(19) United States
(12) Patent Application Publication
(10) Pub. No.: US 2015/0037781 A1
(43) Pub. Date: Feb. 5, 2015

(54) MONITORING DEVICE AND SYSTEM FOR REMOTE TEST TAKING

(71) Applicants: David S. Breed, Miami Beach, FL (US); Warren Van Genderen, Kirkland, WA (US); Shauna Doyle de Brun, Bothell, WA (US); Peter J. Backman, Bothell, WA (US); Steven Baltazor, Black Diamond, WA (US); Kieran C. de Brun, Seattle, WA (US); Craig Van Genderen, Bothell, WA (US)

(72) Inventors: David S. Breed, Miami Beach, FL (US); Warren Van Genderen, Kirkland, WA (US); Shauna Doyle de Brun, Bothell, WA (US); Peter J. Backman, Bothell, WA (US); Steven Baltazor, Black Diamond, WA (US); Kieran C. de Brun, Seattle, WA (US); Craig Van Genderen, Bothell, WA (US)

(21) Appl. No.: 14/449,529

(22) Filed: Aug. 1, 2014

Related U.S. Application Data
(60) Provisional application No. 61/861,532, filed on Aug. 2, 2013.
(60) Provisional application No. 61/925,035, filed on Jan. 8, 2014.
(60) Provisional application No. 61/970,303, filed on Mar. 25, 2014.

(51) Int. Cl. G09B 7/00

(52) U.S. Cl. CPC G09B 7/00
USPC 434/362

(57) ABSTRACT

Arrangement for remote transaction session for use with a computer having an operating system, including a support structure, at least one audio sensor for detecting sound and arranged on the support structure, at least one radio frequency communication detecting sensor arranged on the support structure, at least one optical imaging device that obtains images of an area including the computer or the user and arranged on the support structure, at least one biometric sensor that receives data about or from a user using the computer to participate in an remote session, and at least one motion sensor system for detecting motion in an area around the user. A processing unit is coupled to the sensors and receives and analyzes data therefrom to (1. verify the identity of the user as the intended, registered participant in an remote session, (2. verify that the user is present within the remote session environment throughout the entirety of the remote session, and (3. verify that the user complies with remote session rules of behavior set by the administrator or institution.

### BACKGROUND

1. Technical Field

The present disclosure relates to a system and device to verify identity, verify presence and verify compliance with rules of behavior in a remote test session or a remote transaction session.

2. Description of the Related Art

There has been a great deal of discussion in the press over the past several years relating online education in general, MOOCs (Massive Open Online Course), and remote monitoring in traditional higher education institutions. Through the use of the Internet, education can be freely distributed to anyone who has Internet access. It is now generally recognized that mastery of almost any field taught in traditional colleges and universities can be achieved by a motivated student without physically attending lectures at that college or university. Thus, the technology is and has been in place for a student to obtain the knowledge that has previously only been available to a campus-resident, matriculated student at a college, university or other institution.

One issue that arises with remote students is testing and a corresponding risk of cheating. The risk of cheating discourages some institutions from offering degrees to remote students because of the difficulty monitoring their remote test or other transaction session environments. Institutions want to maintain their brands and reputations and thus desire students that will enhance the credibility of the institution.

Many current solutions rely on human proctoring or onsite proctoring solutions. Others provide a limited level of validation by downloadable tests with authentication codes. These do not confirm that the student is the actual student expected to take the test and do not prevent the student from getting help from another person in the same location. Examples of prior solutions include U.S. Pat. No. 5,565,316 (Kershaw et al), U.S. Pat. No. 5,915,973 (Hoehn-Saric et al.), U.S. Pat. No. 5,947,747 (Walker et al.), U.S. Pat. No. 7,069,586 (Winneg et al.), U.S. Pat. No. 7,257,557 (Hulick), and U.S. Patent Publication 2007/0117083 (Winneg et al.).

### BRIEF SUMMARY

The present disclosure is directed to a computing device that monitors online or remote users to ensure the user identity, presence and behavior as defined by the administrator or institution sponsoring the remote session. In another embodiment of the present disclosure, a standalone monitoring system is provided that couples to a user's computer to monitor an online or remote session. The standalone monitoring system includes a plurality of sensors to monitor the user during the session. For example, the monitoring system may include motion sensors and image sensors, fixed and movable, to monitor the user and the user's environment. In addition, the monitoring system may include a plurality of biometric sensors for verification of the user's identity, presence and behavior during a session. A heart rate monitor may be used to monitor pulse, where the system notes an anomaly if the heart rate changes over a period of time.

In another embodiment, a computing device for a monitoring session has a limited operating system and includes a support structure, at least one sound sensor for detecting audio and arranged on the support structure, at least one radio frequency communication detecting sensor arranged on the support structure, at least one optical imaging device that obtains images of an area including the computer and/or the user and arranged on the support structure, at least one biometric sensor that receives data about or from a user while operating the computer during a session, and at least one motion sensor system for detecting motion in the immediate environment surrounding the user. A processing unit is coupled to the sensors and receives and analyzes data to determine whether the user is interacting with another person and/or whether the user is receiving communications from another person.

### BRIEF DESCRIPTION OF THE SEVERAL VIEWS OF THE DRAWINGS

The following drawings are illustrative of embodiments of the system developed or adapted using at least one of the embodiments disclosed herein and are not meant to limit the scope of the disclosure as encompassed by the claims.

FIG. 1 depicts a typical user environment with a user operating a computing device formed in accordance with one embodiment of the present disclosure.

FIG. 2 is a standalone monitoring device formed in accordance with another embodiment of the present disclosure.

FIG. 3A is a block diagram associated with components usable with the computing device of FIG. 1 or the standalone monitoring system of FIG. 2.

FIG. 3B is a block diagram of an array of sensors usable with the computing device of FIG. 1 or the standalone monitoring system of FIG. 2.

FIG. 3C is a block diagram of components integrated with the computing device of FIG. 1 or the standalone monitoring system of FIG. 2.

FIG. 4 is a block diagram of a standalone monitoring system in a networked environment in accordance with an embodiment of the present disclosure.

FIG. 5 is a flow chart of an example of a session performed in line with embodiments of the present disclosure.

FIG. 6 is a pattern recognition flowchart using neural networks for identifying the users' biometrics.

FIGS. 7A-7E are alternative embodiments of a standalone monitoring system with a variety of head-mounted devices according to the present disclosure.

FIG. 8 is an alternative embodiment of a standalone monitoring system.

FIG. 9 is a block diagram of electronic components of the standalone monitoring system of FIG. 8.

FIG. 10 is a representation of areas around the user and types of sensing or monitoring in these areas according to the present disclosure.

FIG. 11 is a representation of a room utilizing more than one standalone monitoring system.

FIGS. 12A-12E are embodiments of computing devices that include chassis intrusion detector systems.

FIG. 13 is a schematic of the operation of the chassis intrusion detector system of FIGS. 12A-12E.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures associated with electronic computing devices have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in the specification and appended claims, the use of “correspond,” “corresponds,” and “corresponding” is intended to describe a ratio of or a similarity between referenced objects. The use of “correspond” or one of its forms should not be construed to mean the exact shape or size.

In the drawings, identical reference numbers identify similar elements or acts. The size and relative positions of elements in the drawings are not necessarily drawn to scale.

The present disclosure is directed to a computing device 104 or a standalone monitoring system 20 configured to monitor a remote user 101 in a remote test taking or other transaction environment 100 to ensure compliance with behavioral parameters, i.e., to prevent cheating. The automated monitoring is conducted by components embedded in the secure computing device 104 or in the standalone monitoring system 20. The monitoring occurs without an on-site proctor or a remote proctor, i.e., the remote test or transaction session is executed with no other human interaction besides the user.

The embodiments of the present disclosure will help users located anywhere in the world obtain value from an online test session or other remote transaction session without having to travel to the physical location of the transaction. With the remote monitoring device, the user can prove mastery of the information by passing a series of assessments or examinations. With the remote monitoring device, the remote session administrator can have comfort that the user actually mastered the information without in-person monitoring or supervision.

The computing devices 104 or standalone monitoring systems 20 of the present disclosure may be utilized by educational institutions, like colleges or universities, offering online courses, by corporate institutions for training and compliance, remote workforce monitoring and time-tracking, remote healthcare monitoring, and other transactions or relationships that benefit from verification of identity and validation of a security level of the environment.

One objective is to provide confidence to the degree or certificate granting institution that the user who is taking a test is in fact the user who has registered for the course and that the user is acting alone without the aid of a consultant who may be remote or nearby.

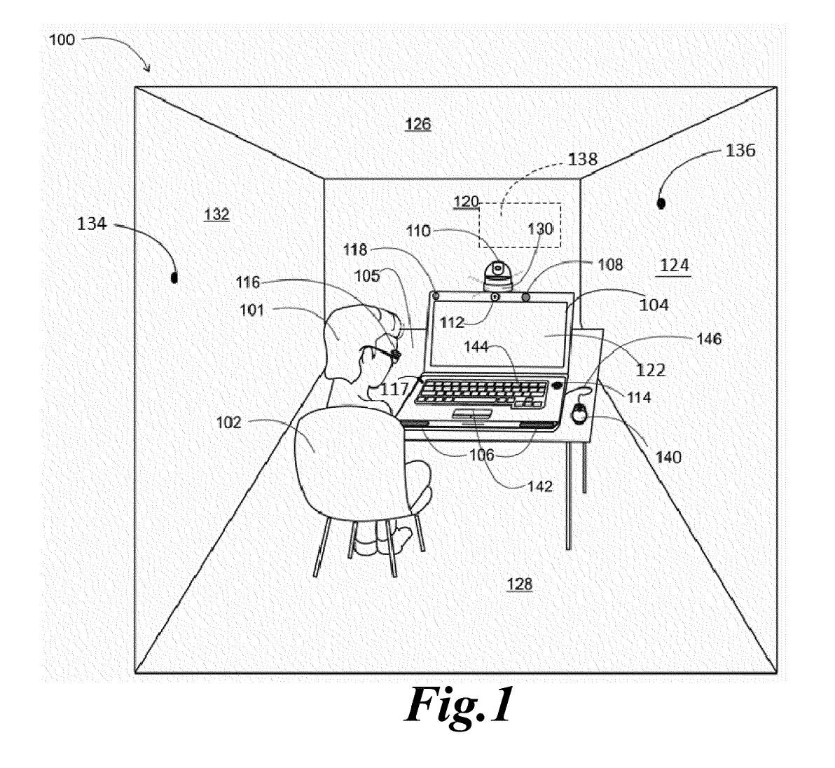

FIG. 1 is an example of a remote transaction session environment 100 in which a user 101 is positioned for an assessment, such as an examination or an authorized transaction that can benefit from verified identity, to name a few. In this embodiment, the user 101 is the only user in the remote session environment 100. For example, this may be a room in the user's home. The user 101 sits on a chair 102 facing a secure computing device 104 that is supported on a table 105. In this embodiment, the computing device 104 is a laptop style computer having a monitor 122, a keyboard 144, and an input device, such as a mouse 140 or a track pad 142. The mouse 140 may be wireless or coupled to the computing device with a fixed wire 146. In one embodiment, the mouse 140 may be permanently fixed to the computing device or be connected through a special connector specific to the computing device. If wirelessly connected, a wireless protocol can provide secure communication between the mouse and the computing device to limit or monitor the messages sent from the mouse. Bluetooth or other standard protocols can be used.

Other embodiments of the computing device include a tablet, a desktop and monitor combination, or other types of computing devices sufficient to administer the test. The monitor may be touch screen capable and may receive inputs from the user.

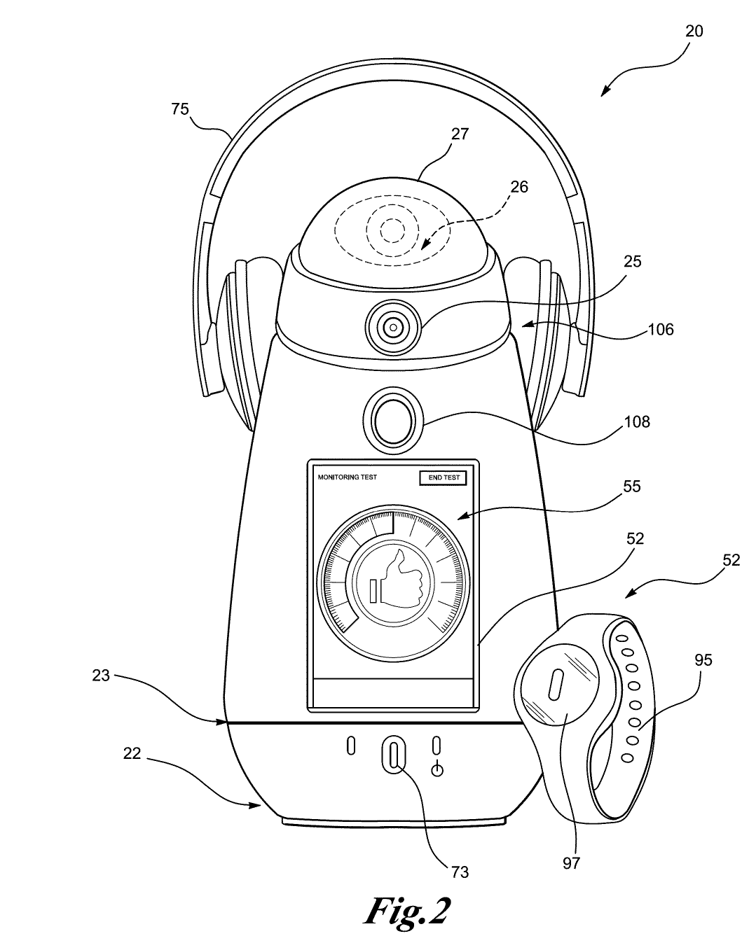

FIG. 2 is the standalone monitoring system 20 configured to be coupled to a standard computing device, such as a laptop of the user, to administer a test and monitor the user 101 and the remote session environment 100 during a remote session. The standalone monitoring system 20 may be used as an alternative to the computing device 104 in the test environment 100.

The standalone monitoring system 20 includes a tower 47 that has a base 22 that is smaller than a widest portion 23 of the tower 47. The tower 47 is configured to remain upright, even if bumped during the remote session. A bottom surface of the base 22 may be circular, oval, or polygonal. Although the tower 47 may have separate pieces until assembled, the tower 47 is tamper proof once assembled. There may be tamper detection circuitry 59 or alarms that will be activated if the tower 47 is tampered with. Alternatively, the tamper detection circuitry 59 may be configured to record an anomaly that is stored as part of the remote session data. In other embodiments, the tamper detection circuitry 59 is configured to deactivate or otherwise prohibit further use of the standalone monitoring system 20 if tampering is detected.

The tower 47 includes a power button 73 that activates the standalone monitoring system 20. It may also include a battery for backup power in case of a power outage.

The standalone monitoring system 20 also may include a headset 75 that is configured to provide sound notifications to the user and may be configured to monitor biometrics of the user. For example, the headset may include a pulse detector or motion detectors to determine if the user remains in a dictated location or within a range of the tower. The headset 75 may house a third camera as opposed to the user wearing glasses with a camera.

The standalone monitoring system 20 may also include a wearable electronic device 95 or other monitoring device. The wearable electronic device 95 may include biometric sensors 52, such as a pulse detection sensor, a three-axis accelerometer, a GPS module, an RF sensor, an RFID or NFC chip, a galvanic skin response sensor, or other sensor to detect stress or continued presence or proximity to the standalone monitoring system 20. The wearable electronic device may be configured to alarm or vibrate if the wearable electronic device is moved out of a range from the standalone monitoring system 20. The wearable electronic device 95 may include electronic components for wireless. The wearable electronic device should not interfere with the user's ability to perform during a remote session. In one embodiment, the wearable electronic device is replaceable, such that different wearable electronic device versions can be used with the standalone monitoring system 20. The wearable electronic devices 95 are also adjustable, giving the user the flexibility to make the device fit comfortably. The wearable electronic device 95 may also include a user interface 97 that may provide information to the user, such as a display of biometric or other data in real-time.

The wearable electronic devices bracelet may process the biometric sensor data locally or may simply transmit the sensor data to the standalone monitoring system 20. The sensor data is stored as part of the remote session data, with video from the first camera. If the sensor data indicates an anomaly, the system 20 will perform a set of steps to record information about the environment around the anomaly. For example, if the bracelet detects a sharp increase in the pulse of the test taker, the system will store video data for a period of time before and after the notification of the anomaly, and will capture images of the environment with the second camera to be stored.

Both the standalone monitoring system 20 and the computing device 104 include embedded monitoring components that verify the identity of the user and monitor the remote session environment 100 for a duration of an entire session. The standalone monitoring system 20 and the computing device 104 monitor the user and the remote session environment automatically without intervention or interaction of any other human. The standalone monitoring system 20 and the computing device 104 provide an institution with confidence that the user is the actual individual registered for an remote session.

When each user enrolls at an institution, the user will register with the institution. During this registration process, the user can provide identification information, such as traditional information like name, social security number, address, and biometric information, such as finger print, palm print, voice print, retinal scans, facial features, and other information that will permit the user to be identified remotely, such as over the Internet.

For each remote session, the administrator or the institution may dictate the monitoring parameters associated with the remote session. The monitoring parameters are transmitted to the computing device 104 or the standalone monitoring system 20. Alternatively, if the institution has a set of monitoring or session administration parameters that apply to all of the remote sessions offered by the institution, the computing device 104 and the standalone monitoring system 20 may be pre-programmed or programmed at registration. The computing device 104 and the standalone monitoring system 20 will monitor the remote session environment 100 and the user 101 and determine if the monitoring parameters are complied with or violated. If violated, the remote session may be rendered invalid, i.e., no credit would be given. The parameters will identify types of behavior that will cause an anomaly to be identified. The institution can set a number or type of anomaly that will render the remote session invalid. Other parameters may include a number of times that the remote session can be restarted, the number of times that a particular remote session can be retaken, the time permitted to take the remote session, and the number and length of pauses permitted during the remote session process. These parameters may or may not be provided to the user 101. Regardless of whether the user is informed of the parameters, the computing device 104 and the standalone monitoring system 20 can notify the user when their behavior or when the remote session environment is not in compliance with the parameters.

The computing device 104 monitors the user 101 and the test environment 100 with a first camera 112 that faces the user 101 and a second camera 110 that captures images of the environment as a whole. The standalone monitoring system 20 also includes a first camera 25 that faces and monitors the user 101 and a second camera 26 that monitors the environment. The second cameras 110, 26 may include a wide angle camera, a rotatable camera, and a panoramic or other camera capable of capturing images of the complete remote session environment, such as 360 degrees around the user. If the table 105 is glass, the second cameras 110, 26 could detect anomalous conditions happening beneath the table. However, if the table is not transparent, the second cameras will image the test environment that is visible, such as a top surface of the table, walls 124, 120, and 132, a ceiling 126, and visible portions of a floor 128. The second cameras can image in all directions around the user so that if a consultant is in the remote session environment, the additional cameras can detect their unauthorized presence.

Both the computing device 104 and the standalone monitoring system 20 may include a microphone(s) 108, and speakers 106. The computing device 104 includes biometric sensors 114 and the standalone monitoring system 20 includes biometric sensors 52. The biometric sensors 114, 52 may include a combination of a fingerprint reader, a temperature detector, a galvanic skin response reader, a pulse detector or heart rate monitor, or other stress or deception detectors.

These biometric sensors 114, 52 may be integrated into the computing device 104 and the standalone monitoring system 20 in a manner that any tampering will be detected and indicated as anomaly associated with a potential violation of the parameters. Alternatively, the biometric sensors 114, 52 may be external components that are configured to be securely added or removed depending on the parameters for confirmation of identity and verification of the integrity of the test environment set by the institution.

Motion detectors 130, 131 may be incorporated adjacent to second camera 110, 26. The motion detectors 130, 131 may be an ultrasonic motion detector that includes an ultrasonic transceiver assembly axially in-line with the any camera 110, 26.

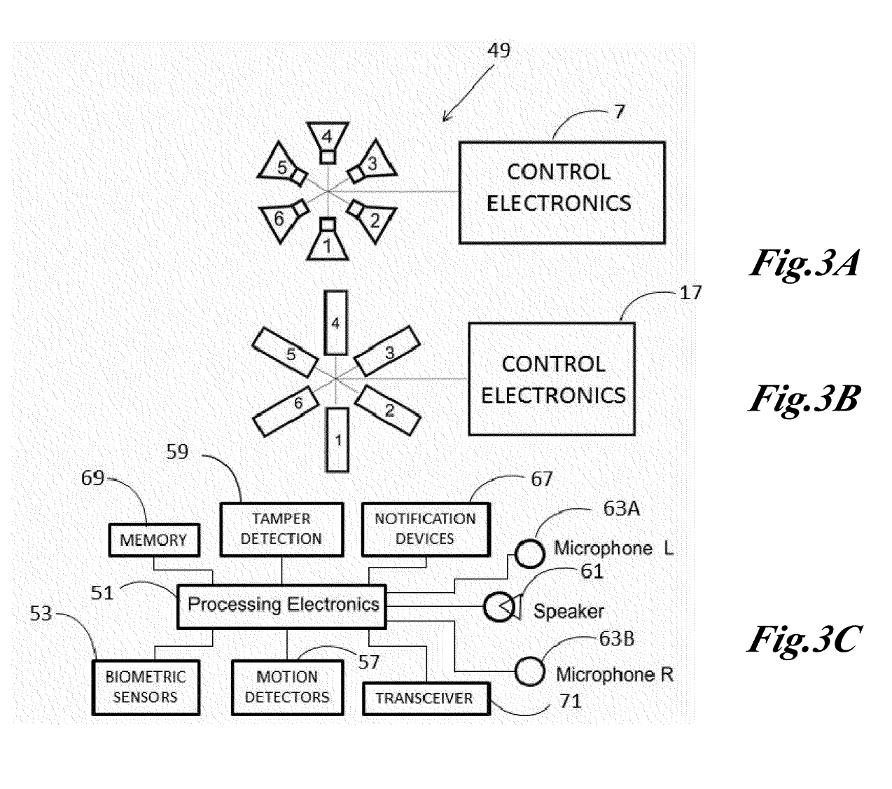

FIG. 3A is a block diagram of an embodiment of an ultrasonic transceiver component 49 that can be included with the computing device 104 or the standalone monitoring system 20. This embodiment includes six ultrasonic transceiver 1-6 each with an approximately 60° angle for transmission and reception. The transceiver 1-6 are coupled together and controlled by common control electronics 7. The transceivers are arranged in a circular arrangement allowing them to detect around the entire test environment. These ultrasonic transceiver can be used for detection motion, distance measuring, level monitoring, presence detection, ranging, proximity sensing and many other automated, applications.

The control electronics 7 may be integrated within the computing device 104 or the standalone monitoring system 20. Software included in the computing device 104 or the standalone monitoring system 20 can communicate with the control electronics 7. For example, the transceiver 1-6 can periodically emit signal at a selected frequency, such as 40 kHz. This signal will travel from the transceiver into the environment around the user. Using range gating, during a first time period from the transmission of the signal, a return signal can be eliminated as representing a first radius around the computing device 104 or the standalone monitoring system 20. The transceiver may also eliminate a return signal received after a second period of time, which can represent a second radius. Accordingly, the transceivers will detect and process the return signal during a third period of time that is between the first period and the second period. The first radius may be 2 meters and the second radius may be 10 meters, this may corresponds to a first time period of approximately 12 milliseconds and a second time period of 60 milliseconds. The software can then compare successive receptions to determine whether there has been any change in those receptions and, if so, the software can indicate that there is a moving object in that 2 to 10 m range. Such an object may be a consultant sending messages by gestures or signs, for example, to aid the user 101.

FIG. 3B is a block diagram of an array of image sensors 11-16 and control electronics 17 that can be integrated with the second cameras 110, 26 of the computing device 104 or the standalone monitoring system 20. The plurality of image sensors 11-16 are arranged circularly, where each has an approximately 60° field of view. Each of the image sensors are coupled to control electronics 17, which merge images to create a 360° representation of the test environment. The merged images or a series of the images are analyzed by a pattern recognition algorithm, such as a neural network to understand the test environment. When the remote session begins, a baseline merged image or series of images is prepared and stored for later comparison. As the remote session proceeds, the array of image sensors may periodically capture a subsequent merged image or series of images. This subsequent merged image can be compared to the base line image for anomalies.

When using the computing device 104, there is a preferred position for optimal imaging. For example, the housing 115 can be at a particular angle, such as 135 degrees. The computing device 104 may be configured to turn off or go into a sleep mode if the housing is rotated past a predetermined angle during the remote session. A tilt sensor can be incorporated in the computing device 104 to measure the angle of the housing with respect to the table or a base 117. If the base is not perpendicular to the gravity vector, that is parallel to the floor within about 5 degrees, then second camera 110 will not properly record the surrounding space and the user will be warned to find a flatter surface for taking the remote session.

FIG. 3C is a block diagram of components integrated with the computing device 104 or the standalone monitoring system 20. The components includes processing electronics 51, which may be a single processor, a multi-core processor, an application specific integrated circuit, or a combination of various electronic devices suitable to process and control the various components for user identification, behavioral observation and analysis, and test environment observation and analysis. Motion detectors 53 are coupled to the processing electronics 51 along with a plurality of biometric sensors 57. In addition, the processing electronics 51 control a speaker 61 and a first and second microphone 63A, 63B. The speaker 61 can be used in a startup or boot up phase to emit a sound that is confirmed by receipt at the first and second microphone. The sound can be of a form that is not objectionable or distracting to the user 101. This can take the form of a frequency which is above or below the human hearing range or of a low level static for example.

The processing electronics 51 are also coupled to notification devices 67. With regard to FIG. 1, the notification devices 67 include an indicator light 118 that gives a light indication that the test is underway, which can alert others not to interfere with the test taking process. This light 118 would be typically on during the test taking process and be turned off after the remote session is complete. The light 118 may include a variety of light emitting devices, such as different colored LEDs. The light 118 can indicate that an anomaly has been detected, i.e., there is suspicious activity underway, such as another person in the test environment 100.

With regard to FIG. 2, the notification devices 67 may include a display panel 55 that is configured to provide an indication that a remote session is in progress, similarly to the light 118. The display panel 55 may be a touch screen panel for receiving inputs from the user and may be able to display colors.

When an remote session is underway, if anomalous behavior is detected by the system, the light 118 or the display panel 55 can indicate with a color scale that something anomalous is underway. When the conditions in the remote session environment are compliant, the light 118 or the display panel 55 can provide a green light. As the computing device 104 or the standalone monitoring system 20 detect something anomalous, the light 118 or the display panel 55 may provide a yellow light or a red light. The color emitted may indicate the severity of the anomalous behavior detected. In addition, the light 118 or the display panel 55 may blink or otherwise have an intermittent pattern indicative of the situation being detected. The color or pattern can aid the user in correcting the behavior to be in compliance. The display panel 55 may provide a written indication of the type of anomalous behavior detected.

Each of these notification devices may be embedded in the computing device 104 or in the standalone monitoring system 20, such as a printed circuit board held within a central portion of the tower 47. The processing electronics 51 is also coupled to tamper detection circuitry 59 in some embodiments. In addition, a memory or other storage device 69 and a transceiver 71 are coupled to the processing electronics 51. The transceiver may be enabled for wireless communication or wired communication, such as connecting to the internet or a testing network. In one embodiment, the computing device 104 is configured for test taking alone and will not be available for generic internet usage.

As understood by one skilled in the art, appropriate apertures, supports, couplings, are provided to enable electrical and signal coupling between a processor and each device, such as the biometric devices, the first and second cameras, and other sensors described herein. For the computing device 104, the processor can be the same processor on a motherboard that controls operations of the computing devices or the processor may be a separate processor associated with only the secure monitoring components. In this embodiment, the computing device 104 has limited operating capability, specifically for test taking purposes only. For the standalone monitoring system 20, the processor is embedded within internal circuitry of the system 20. The user's separate laptop or computer will have its own processor. The standalone monitoring system 20 is configured, in one embodiment, to prevent the user's separate laptop or computer from performing other functions besides the remote session being administered.

The second camera 110 may be added as a separate component that attaches to a housing 115 or integrated within the housing 115 of the computing device 104. In one embodiment, the second camera 110 and the motion sensors 130 can be provided in a package that can fold into a compartment (not shown) in the housing 115 of the computing device 104. This package can help with ease of transportation and prevention of damage of the additional camera.

In the standalone monitoring system 20, the second camera 26 may be housed within a tamper-proof cover 27. Additional components, such as the motion sensors 130 may be included within this cover 27.

If the remote session is a closed book exam, where the presence of textbooks or notes is forbidden, the user 101 may wear a detection device 116 to capture information about what the online or remote-session-taker is viewing. The detection device 116 may be a camera coupled to glasses, a device such as Google Glass, a camera coupled to headphones, or another type of headset that includes a detection device. The detection device 116 will record the field of view which is seen by the eyes of the user 101, which will capture information about any visual aids viewed or utilized by the user 101. In order to assure that the detection device 116 is properly worn, the first camera 112 or the second camera 110 can be used to monitor the user 101 for the presence and proper use of the detection device 116. More generally, a verification system, whether embodied as hardware or software, may be included with the detection device 116 to verify that the detection device 116 is properly worn by the user 101. For example, the user can be instructed to look at the first camera 112 and the field of view seen by the head detection device 116 can be compared with what would be expected if the camera is properly worn. If an unexpected field of view is detected by the first camera, the user can be instructed to adjust the detection device 116.

The biometric sensors 114, 52 are to provide identification of the user during an initialization phase and periodic or consistent monitoring of the user 101 during the remote session. The biometric sensors 114, 52 can include a variety of detection devices that can be used to verify the identity of the user and that can monitor a stress or deception level of the user during the remote session.

When the user purchases, rents, or otherwise acquires the computing device 104 or the standalone monitoring system 20, an initial biometric profile can be created. The biometric profile may be created at a later stage as well. In one embodiment, the biometric profile is stored in a portion of the memory 69 that is not accessible by portions of the computing device 104 and the standalone monitoring system 20 that are configured to transmit and receive correspondence from an external source, such as a website or a database, i.e., the portion of the memory 69 is only accessible by the processing electronics 51 for an unlock sequence. The unlock sequence will allow the user to login to the computing device 104 or the standalone monitoring system 20. Once unlocked or logged in, the portion of the memory 69 becomes inaccessible.

The biometric profile will include more than one identifying feature. For example, the biometric sensors 114 of the computing device 104 can be a fingerprint or palm print scanner. The display panel 55 may be a touch screen that can record fingerprints or palm prints. From the palm print, measurements of hand geometry can be recorded. Alternatively, detecting patterns of blood vessels in the hand (front or back) can be used as user identifiers. The first camera 110, 25 and the second camera 112, 26 alone or in combination can perform facial recognition and retinal or iris scans of the user. With appropriate processing, the facial recognition may track and save identifying data from facial blood vessels. A simpler technique will save a three-dimensional model of the shape of the user's head.

The facial scan can be obtained via the first or second camera. In addition, the first and second camera can be used in conjunction with the biometric sensors to image the pattern of blood vessels in the user's face, in which case, an infrared illuminator should also be used (not shown). The illuminator would be mounted on the support.

The microphone 108 can be used to record the voice of the user 101 and produce a voice print, which would be unique to that particular person. In this case, each time the user 101 takes an remote session, they could be require to speak a sentence to enable comparison of the recorded voice print to the current voice print. Thus, the microphone can be part of a verification system for multiple remote sessions to ensure the same user 101 is taking multiple tests in a series of remote sessions.

Other biometric techniques include having the user 101 sign a provided pad surface which can be also an integral part of the surface of the computing device 104 or tracking a typing or keyboard stroke style.

In one embodiment, a combination of two types of biometric information will be used, such as fingerprints and face recognition. More than one type of biometric information is used because none of the biometric sensors are 100% accurate alone. However, a combination of the two or more can achieve very high accuracy of identification. The biometric sensors could include lab on chip type sensors that can identify the user by blood, saliva, or breath.

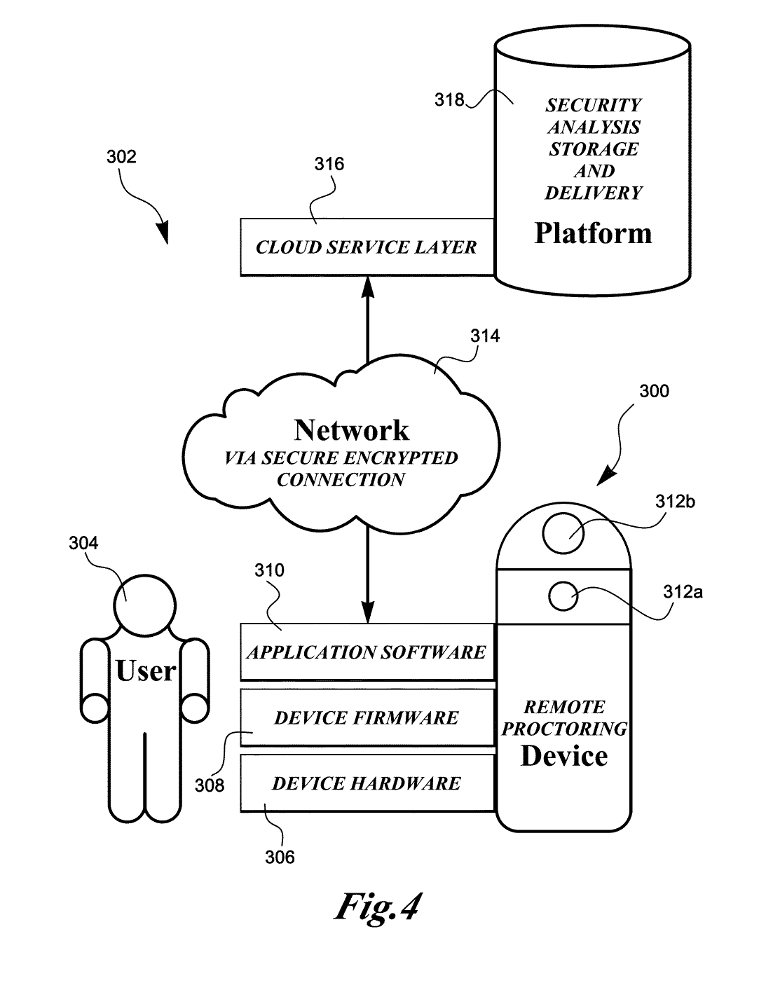

FIG. 4 is a block diagram of a standalone monitoring system 300 in a networked environment 302 in accordance with an embodiment of the present disclosure. The standalone monitoring system 300 is in a user's 304 home or test environment. The standalone monitoring system 300 includes a variety of components as described in the various embodiments included in this disclosure. The standalone monitoring system includes hardware 306, firmware 308, and application specific software 310. The hardware 306 includes a plurality of sensors 312a, 312b, such as cameras, microphones, biometric sensors, and other devices described herein. The software 310 processes and analyzes data collected by the hardware and transmits remote session data through a network 314. The network may be a wired connection or a wireless connection. The data may be transferred in a secure encrypted format.

In one embodiment, the network communicates with a database 318 stored in the cloud, through a cloud services layer 316. In other embodiments, the database 318 may be a series of privately owned servers with a direct communication link to the network 314. In some embodiments, all or some of the analysis and processing is performed remotely from the standalone monitoring system in the database 318. In other embodiments, the analysis is performed locally in the standalone monitoring system and transmitted to the database.

If test data is transferred using an encryption/decryption scheme, the following may be a series of steps associated with this process. The remote session is downloaded from the network. A private key is retrieved to unlock or decrypt the test. The private key may be stored in memory or sent to the user via email or other communication protocols. Next, the remote session is decrypted using the stored private key. Then, a time stamped message is sent to the testing institution indicating that this decryption was successful. Then, the remote session is displayed on the user's monitor waiting for an indication from the user that he is ready to proceed.

The decryption information may be permanently housed in the computing device 104 or the standalone monitoring system 20. Thus, even if another computer can intercept the remote session while it is being downloaded, it will not be able to decrypt the download. The private key used to decrypt the downloaded remote session can be a permanent part of the system and stored in non-volatile memory. To this end, a tampering detection system would be configured to detect tampering with the non-volatile memory component of the computing device 104 to detect whether it has been compromised, accessed impermissibly and then an indication of such access removed. For this reason, the computing device 104 will preferably contain diagnostic checks to ascertain whether the computer has been tampered with. If there is an indication of tampering, upon the next linking of the computer 104 to the Internet, an error code will be uploaded and the computing device 104 declared invalid for future test taking purposes.

These diagnostic checks may be resident in computer-readable storage media that form part of the systems. It is also possible for the tampering detection system of the computing device 104 to be partly resident at a remote site. In this case, the remote site would send a command to the computing device 104 to perform a diagnostic check to detect tampering with the computer 104. If such tampering is detected, the remote session may not be downloaded, i.e., the computer 104 has been compromised and can no longer be used.

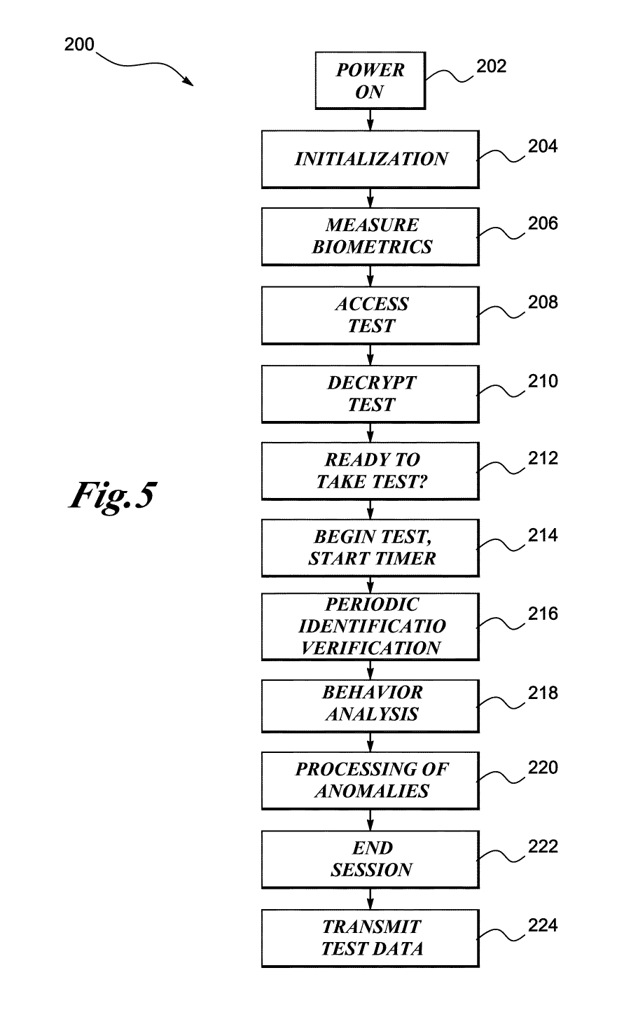

FIG. 5 is a flow chart of an example of a remote session 200 executed in line with embodiments of the present disclosure. At step 202, the user powers on the computing device 104 or the standalone monitoring system 20. This begins an initialization step 204 that accesses the stored biometric profile and other user information. At step 206, the biometric information of the user is measured and checked to validate that this user is authorized to use this device. In one embodiment, the biometric information is stored only locally in the memory. In other embodiments, the biometric information is stored in a database. In this embodiment, the computing device 104 and the standalone monitoring system 20 have to connect to the database before the biometric information is compared and checked. In this case, the comparison can determine if the user is the appropriate user to be taking the remote session. The biometric information may include the user's identification number.

At step 108, the remote session begins to be automatically downloaded after the user's biometric identification is confirmed. Alternatively, the remote session is downloaded previously in preparation for the appropriate window of time for the remote session. Alternatively, the remote session may enter the session identification to access the remote session. Software at the institution can determine the appropriate test to be provided to the user, for example, based their progress to date.

At step 210, the remote session is decrypted and processed to begin the session. The initial page of the remote session is then displayed on the display of the computing device 104 or on a monitor coupled to the standalone monitoring system 20. The user is prompted to indicate their readiness to start the remote session at step 212. Once initiated, a test timer begins and the light 118 or display panel 55 is illuminated at step 214.

At step 216, periodic identification verification is performed. If no anomalies are detected, the remote session continues uninterrupted. If an anomaly is detected, the anomalous data is stored and the processing electronics 51 may control the first and additional cameras to capture images of the test environment. The images are saved with the anomalous data for processing and subsequent review. In some embodiments, the periodic identification verification may be a prompt that interrupts the test requesting the user perform a biometric confirmation, such as a finger print scan or a voice print confirmation.

If an anomalies is detected, an alarm may sound or the light or display panel may flash. When an anomaly is logged, the user may be notified. This can be an option selected by the user or dictated by the test giving institution. Giving the user notice can give them an option to correct the anomaly, such as if the anomaly is associated with the user's position with respect to the first camera. A simple rotation in their seat or a shift of position may correct the anomaly.

Some anomalies include a change in the ambient light (too high or too low), power loss to the system, communication loss if the remote session data is being transmitted during the test, motion detection outside of the user's radius, detection of a cell phone or other mobile device, elevated pulse rate, detection of unexpected audio, keystroke pattern abnormalities, failure of first or second camera, and mechanical intrusion detected. Other anomalies that are stored that occur prior to the remote session include unlock or login failure, voice authentication failure, facial recognition failure, microphone inoperative, and thumb print mismatch.

At step 218, behavioral analysis is performed. This may be continuously or periodically through the remote session. The frequency of behavior checks can be dictated by the test giving institution. The behavioral analysis processes readings from the different biometric sensors that are passive, such as pulse and heart rate detection, eye movement anomalies, position of the user with respect to the first camera, etc.

In some embodiments, the remote session is conducted while the computing device or the monitoring device is coupled to the internet and can transmit the session date as it is collected. In other embodiments, the computing device 104 and the standalone monitoring system 20 remain unconnected from the internet during the remote session. Once completed, the remote session data is processed and then uploaded to the cloud or database.

Once the test is completed, the anomalies are processed at 220. At 222, the remote session is completed and a set of test data is complied. The remote session data includes information about anomalies. At 224, the session data is transmitted to the institution through a hard connection or wirelessly. Once transmitted the light 118 or the display panel 55 can indicate that the remote session is now complete.

FIG. 5 is a pattern recognition flowchart shown generally at 400. The general pattern recognition process can be used for any of the biometric data retrieved by the sensors listed above including facial recognition, voiceprint, palm print, fingerprint, signature recognition, or any of the other pattern-based biometric identification systems. The biometric data is acquired at step 402 and inputted into a pattern recognition algorithm that is trained neural network at 404. If verified, this information is sent to the institution, which returns a code indicating that it is okay to proceed with the remote session taking process at step 406. Specifically, the institution compares the result with the stored biometric data and indicates whether the remote session taking is allowed to proceed so that the test taking procedure proceeds at step 408. Alternately, the appropriate neural network check of the biometric test data can be accomplished at the institution or in the cloud, in which case, the data is transferred to the institution. If agreement between the stored biometric data and the newly acquired biometric data does not agree, then the trial count is incremented by one at 410. If the trial count has not exceeded the maximum permitted as determined at step 412, then the user is requested to initiate a re-acquisition of the biometric data and the process repeated. If the maximum number of tries is exceeded, then the test is not downloaded and the user is logged off of the session at step 414.

Returning to FIG. 1 and FIG. 2, the present disclosure is directed to preventing a third party or consultant from assisting a remote user. For example, to prevent a consultant from acquiring an image of the test during the remote session, which can prevent the consultant from coaching the user 101 during the remote session. The computing device 104 prohibits the implementation of screen sharing software or any other technique by which a consultant could simultaneously view the user's display from another location.

One way a consultant can assist is to install a camera 134 in the wall 132 behind the user, to have a view of the screen of the computing device 104 or a monitor viewed by the user. Such a camera would give a consultant, who could be located in an adjoining room, the ability to simultaneously view the examination with the user. The consultant could also have a microphone or speakers 136 in one of the walls 124 or a projector that display images 138 on an opposing wall 120, ceiling 126 or floor 128. The second camera 112, 26 is configured to detect polarized light to prevent a creative consultant from projecting polarized images to assist the user. The consultant could communicate with the user through a small hearing aid, however, the head set (usable with both the computing device 104 and the standalone monitoring system 20) may be configured to detect an unauthorized hearing device. Yet another alternative is a haptic device that could be placed on chair seat or within the clothes of the user 101 that will vibrate in a manner to assist the user 101.

Alternatively, the user may wear a camera on their person to give a consultant information to assist the user with the remote session. The camera could be on a pair of glasses or on the user's collar. To combat this possibility, the first or second camera can scan the user to determine if any unauthorized devices are on the user. In addition, the second camera continually sweeps the room to determine if there are any anomalous things occurring. The sweeping may be in intermitting, random sequences to prevent the user from recognizing the pattern of sweeping. Another possibility is scrambling the screen of the computing device 104 and having the user wear special glasses that unscramble the screen. Also, the microphones can detect unauthorized audio in the test environment.

The computing device 104 may include an electromagnetic shield on the back of the screen to prevent information as to the contents of the display from being sensed by a sensing system mounted out of camera view on the back of the laptop display lid. Additionally, a general electromagnetic receiver, not shown, can be incorporated into the computing device 104 to sense whether there are any spurious electromagnetic signals which might indicate a transmission of information from a consultant to the user. A similar device can be supplied to sense ultrasonic transmissions. For example, perhaps the user is wearing a hearing aid-type device which contains an electromagnetic receiver but which cannot be visually seen by the system's cameras. Highly directional electromagnetic radiation might still be difficult to be sensed by a general electromagnetic receiver and an additional device capable of seeing far infrared or far ultraviolet light may also be included.

The speakers and microphone can assist in preventing assistance by a consultant. For example, the speakers 106 may emit a continual or periodic sound emission along with audio reception and comparison of the sound emission to reception. The monitoring may be initiated when it is known that the online or other remote session-taker is the only person in the room.

The speakers 106 can also be used to validate that a microphone 108 of the computing device 104 is operational. This is accomplished by the speakers 106 emitting periodically a noise which can be sensed by the microphone 108. Since a logical means of communication between a consultant and the user will be orally, the microphone 108 will be used to sense such oral communication. That is, the microphone 108 can be used to monitor noise in the room 100 and determine, for example, that the online or other remote session-taker is talking or a person other than the online or other remote session-taker is talking. In the latter situation, the online or other remote session-taker may be instructed to terminate the remote session and considered to have failed the session. In order to minimize the distraction of sounds, they could be of either very short duration sounding like static or in a frequency range which is beyond that sensed by human ears.

The first camera 110, 26 produces a continuous stream of images which are continuously analyzed by an anomaly detection algorithm to determine if any suspicious events are taking place. The anomaly detection algorithm may be a pattern recognition algorithm that is resident in computer-readable memory 69 of the computing device 104, and executed by the processor. The algorithm may be configured or trained in a training stage to assess a normal situation as well as one or more suspicious situations. Definitions of suspicious situations may be provided, in the training or design stage, so that the pattern recognition algorithm will operationally determine the presence of suspicious event when provided with input from the camera 110. Additional input to the pattern recognition algorithm may come from any other apparatus or component that generates data or a signal based on the conditions in the test environment 100.

The field of view of the first or second camera can be as close to 360° in the horizontal plane as possible. Movement in the field of view of the cameras from any direction will trigger the anomaly detection algorithm to determine whether a person is interfering or communicating with the user 101. In general, if any individual enters into the space around the user 101, it will be assumed that the rules of the test taking process have been violated and an error code initiated.

The first camera 112 is similar to cameras which are frequently present in laptop computers and is used to monitor the operator of the computer, i.e., the user 101. The output from this first camera 112, 25 can be analyzed by an anomaly detection algorithm, such as a pattern recognition algorithm, which will detect any suspicious behavior on the part of the user 101. For example, if the user spends an inordinate amount of time looking at an area which is not covered by camera 110, such as the ceiling or floor, he or she can be advised to stop such looking as the ceiling, for example, may be being used by a consultant to project helping information to the user.

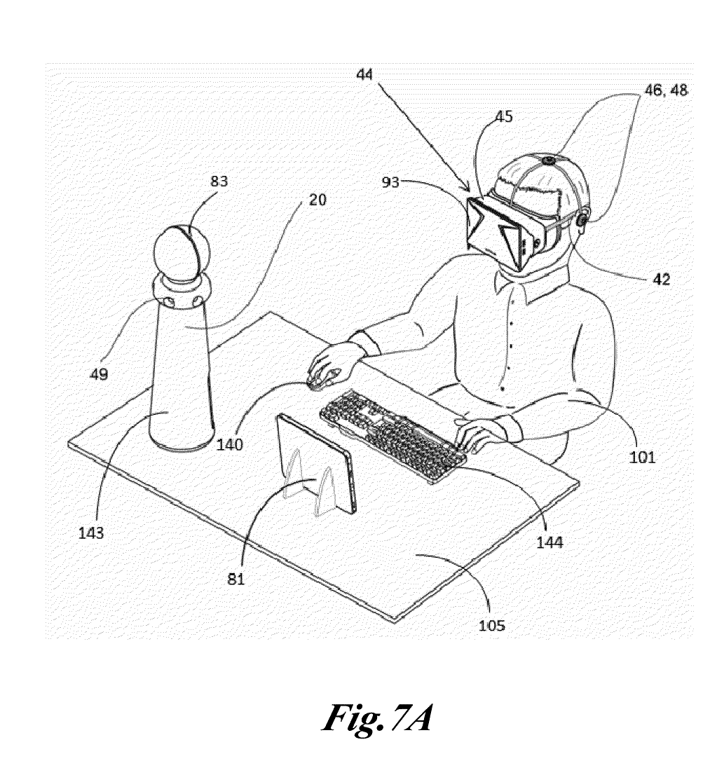

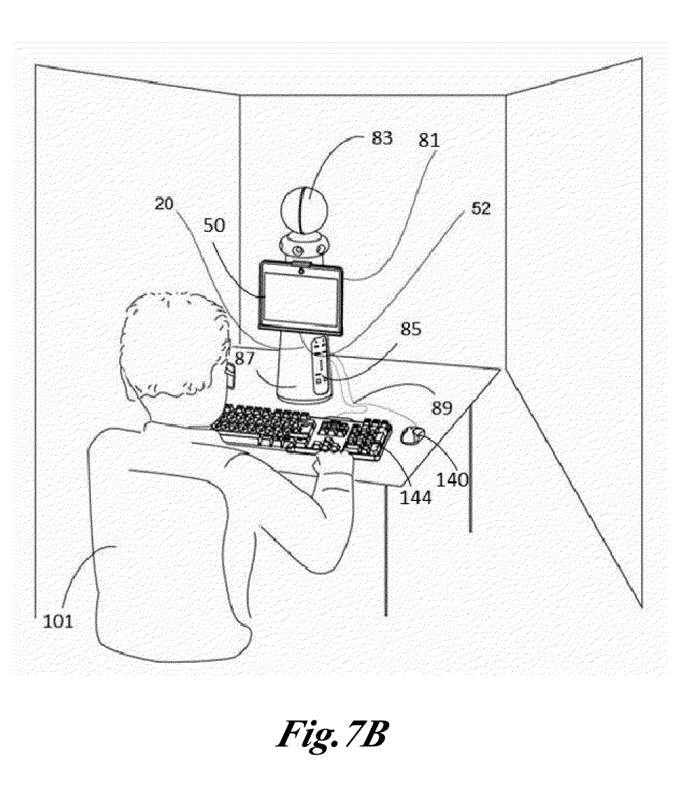

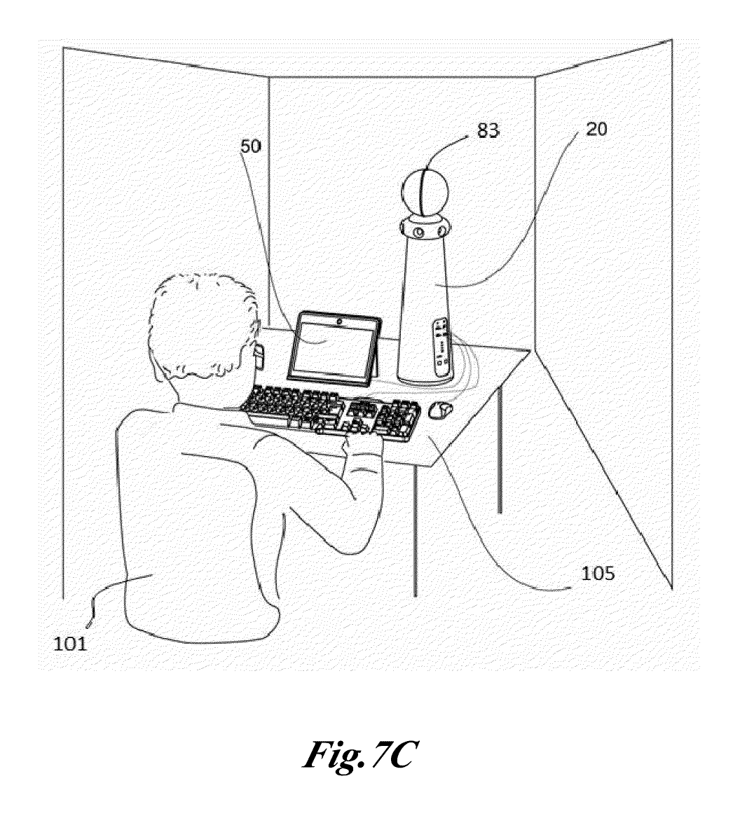

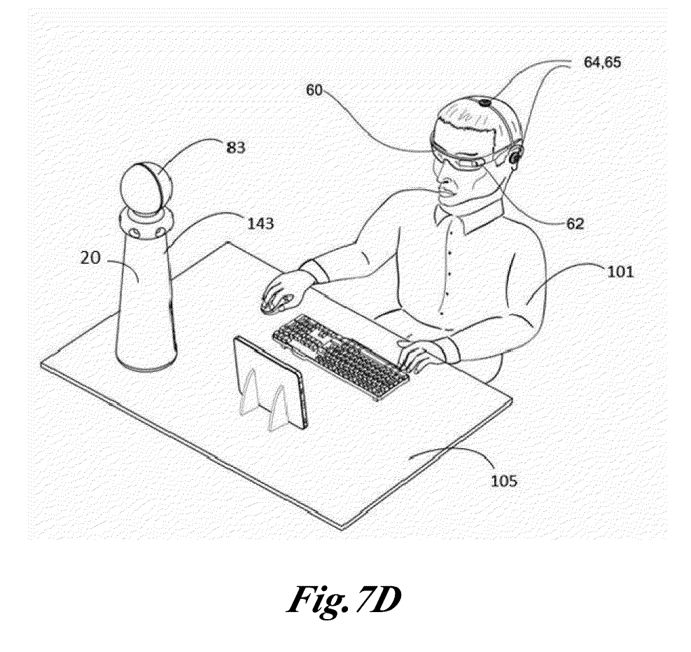

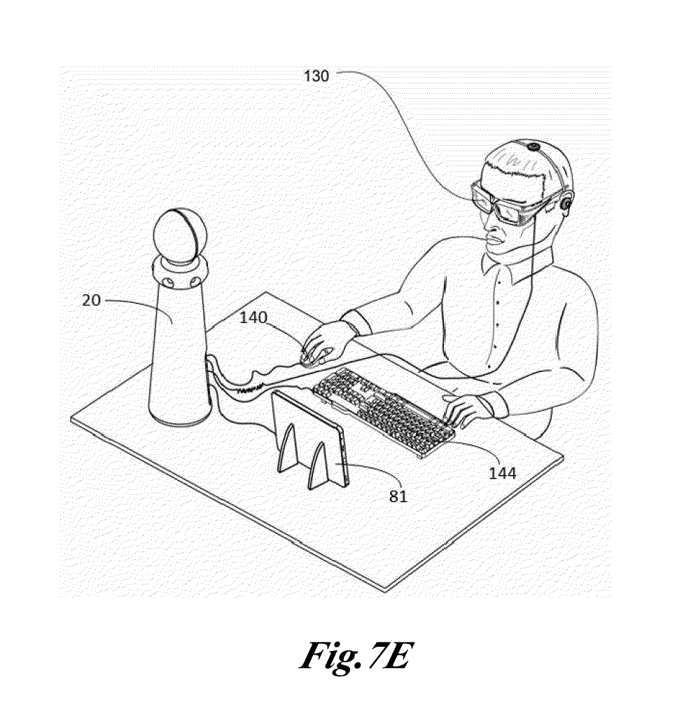

FIGS. 7A-7E are alternative embodiments of a standalone monitoring system 20 with a variety of head-mounted devices according to the present disclosure. In this embodiment, the online or other remote session-taker can use a tablet computer 81 or other non-specialized computing device, such as a personal laptop, on the table 105. The computer 81 couples to the standalone monitoring system 20 wirelessly or through a physical electrical connection 89. The user may include a keyboard 144 and a mouse 140. In addition, the standalone monitoring system 20 includes a head-mounted apparatus 44 that communicates with the system 20.

The system 20 includes a vertically oriented truncated cone shaped support 143, on top of which is at least one camera 83, such as the second camera 110, 26 previously discussed. The cone support 143 may have a flat base or may be a tripod configured to rest on a horizontal surface, or the floor in the vicinity of the user 101. When placed on the floor, the system 20 may be configured to be collapsible, in the same or a similar manner in which a camera tripod is collapsible, and the support may be from about 5 to 6 feet high. When configured for table-top placement or mounting, the height of the system 22 would be less, from about 1 to 3 feet.

The camera 83 may be selected a tetrahedron camera assembly, a spherical camera, a quad camera, an imager with a fisheye lens, and a dual camera that can provide a hemispherical or spherical image, for example as described in U.S. Pat. No. 7,161,746. The dual camera may include fisheye lenses in a single plastic molding, which can be attached to individual image capture chips.

The camera 83 may include a plurality of image capture chips or image capture devices, each configured to provide a different type of image. The camera may include ultrasonic transducers as well. The plurality of image capture devices can be arranged at a variety locations around the system 20 to view nearly an entire area around the computer being used by the online or other remote session-taker. For example, one camera may be configured to view the computer while another is configured to video the online or other remote session-taker or remote session taker.

The system 20 may include a connection port 85 on a connection panel 87 to enable a cable 89 to couple to an internal processing electronics to the computer being used for test-taking, see FIG. 7B. This cable may be a single cable, such as a USB or other electrical connection cable that could extend through an aperture in the cone 143. The system 20 also includes an angle sensor (not shown) that in combination with the camera(s) 83 monitors the environment surrounding the online or other remote session-taker. Other types and combinations of environment monitoring systems and sensors may be used in accordance with the disclosure. The system 20 may also include one or more sound sensors and/or one or more sensors for detecting RF communications that can reach the online or remote session-taker. One or more biometric sensors or other identity-verification sensor or system may be coupled to the processing electronics 51, and may even be integrated into the table computer.

Use of this embodiment would involve the online or other remote session-taker accessing the test-providing website, as described above, and proceed to take the remote session using their tablet computer in the vicinity of the system 20. The system 20 would monitor the presence of other people in the vicinity of the online or other remote session-taker, communications toward the online or other remote session-taker, verify the identity of the online or other remote session-taker, etc., basically a subset or all of the features performed by the computer and arrangement described above.

Another embodiment of the disclosure which may be used in combination with the system 20 or without the system 20 is the head-mounted apparatus 44. The head-mounted apparatus 44 includes a frame 93 that is worn by the online or other remote session-taker on their head and provides a screen in front of their eyes. As shown in FIG. 7A, this frame 93 includes a housing 45 that has the screen and a strap 42 that straps the housing 45 around the user's head. Examples of such head-mounted frames are GOOGLE GLASS™ and OCULUS RIFT™. An advantage of the use of a frame is that only the online or other remote session-taker can view the material being displayed. The system 20 can be used to monitor the position of the user in the environment and can be the conduit to transfer data from the head mounted apparatus to the cloud or database housing the remote session data. In addition, the sound-sensors 48 or microphones 46 may be incorporated with the frame.

The housing 45 of the head-mounted apparatus 44 covers the user's eyes, essentially blocking all external light so that the user can only see the display in the frame 93. This is similar to the sealing effect of goggles used under water. The internal display may be a low persistence OLED (organic light emitting diode) display. The display may be between 7 and 14 inches and be configure to fill the user's entire field of view.

The head mounted apparatus 44 in conjunction with the standalone monitoring system 20 can significantly reduce the likelihood of success of cheating for the user. Although a consultant could potentially have a small camera inside the head mounted apparatus, such as on the user's face, the standalone monitoring system 20 would be able to do scans of the user for anomalies, such as wires or other evidence of interference by a third party. In addition, the standalone monitoring system 20 would sweep the room to ensure no other person is in the remote session environment.

The head mounted apparatus 44 may include radio frequency communication-detecting and sound-detecting sensors 46, 48. In particular, microphones and RF sensors could be incorporated into the strap 42 or into a device which at least partially covers each of the online or other remote session-takers ears. Two microphones, one at each ear, can additionally locate the source of sound coming to the online or other remote session-taker as lying in a plane perpendicular to a line passing through both microphones. If a third microphone is provided at the top of the online or other remote session-taker's head, then the location of the source of a sound can be determined. This can be helpful in differentiating sound from a consultant from road noise in a city, for example. Similarly the use of three RF sensors can pinpoint the source of the RF transmission and if that source is located on the body of the online or other remote session-taker than this becomes significant evidence that there is another device being worn by the online or other remote session-taker which is communicating with a consultant.

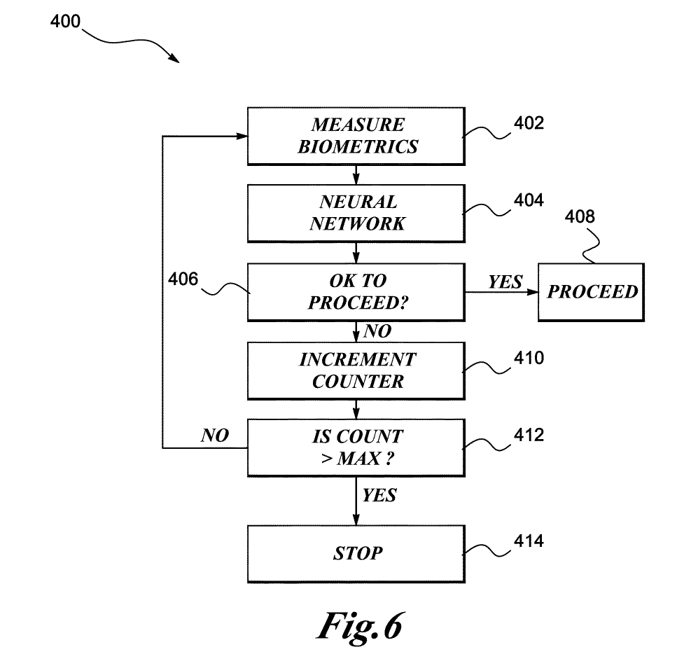

In FIG. 6B, the tablet computer 81 is affixed to the standalone monitoring system 20. A screen 50 of the tablet compute 81 may be positioned at eye level for the user. The position of the tablet computer 81 on the standalone monitoring system 20 may be adjustable. The standalone monitoring system 20 may serve as a docking station for the tablet computer 81, providing electrical connections, and access to the remote session, and security for prevention of unauthorized use of the tablet computer's other features during the remote session. In one embodiment, when positioned on a holding ledge the tablet computer automatically connects to the standalone monitoring system 20 through a micro USB port on the tablet or wirelessly. In addition, a keyboard 144 and mouse 140 may be coupled to the standalone monitoring system 20 through a physical connection or wirelessly.

The camera 83 may include two imaging devices and lenses or may include a linear array of imagers which rotates in order to capture the spherical image. Whichever camera is used, it can be vertically positioned using a small motor which moves the camera vertically upward and downward in order to provide a variety of camera locations.

In FIG. 7C, the tablet computer 81 is placed on the table 105 and coupled by a physical wire 89 to the standalone monitoring system 20. The keyboard and the mouse are also wired to the standalone monitoring system 20.

In FIG. 7D, the user 101 is wearing electronic enabled eye-wear 60 that is configured to communicate with the standalone monitoring system 20 to monitor the user and to provide the user with remote session information. For example, the eye-wear 60 may be similar to the Google Glass technology, which is wearable technology with an optical head mounted display. The user may be able to communicate with the standalone monitoring system 20 with voice commands.

The eye-wear 60 includes a head camera 62 that provides video or images of the remote session environment from the user's point of view. The output of the head camera 62 can be analyzed for the presence of another unauthorized person or unauthorized aids, like a book or flash cards. The eye-wear may also include microphones and RF sensors 64, 65 for additional monitoring of the environment.

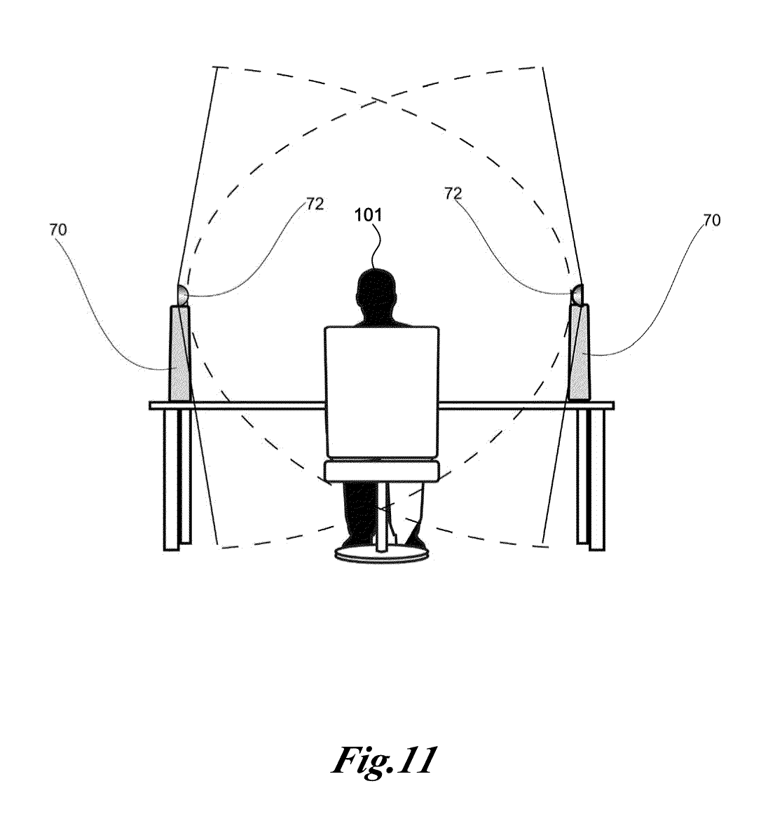

With regard to the camera 83, if there are two hemispherical cameras there may be a dead spot in line with the boundary between the two cameras. To address this potential problem, the two hemispherical cameras 72 can be displaced, see FIG. 11. The two cameras 72 are positioned on separate towers 70 on either side of the user 101. These cameras can be displaced vertically or in any other configuration that is easy to implement and which provides the best view of the room and user.

The standalone monitoring system 20 may also include illumination devices associated with the camera 83 to help illuminate dark portions of the remote session environment and the consultant. This illumination can be in the visual or IR portion of the spectrum. If the consultant moves, their presence will be detectable by the ultrasonic motion detectors, however if the consultant is very still this might not occur so good, clear, analyzable images from the camera are preferred. Another approach is to provide cameras or other imaging device with long wave IR sensing capability in which case the presence of an object whose temperature is above that of ambient can be detected. Thermal IR motion sensors could be used as an alternative to the ultrasonic sensors described above. Ultrasonic motion sensors provide an easier method of locating the source of motion in a room, estimating its size, and permitting pattern recognition systems to identify the object causing the motion. Although these can also be accomplished with thermal IR sensors the cost and complexity is considerably higher.

Returning to the camera 62 worn by the online or other remote session-taker, the camera can snap on to any appropriate glasses frame allowing the user which normally wears glasses to apply the camera to his glasses frame. The head camera typically will have a field of view which is substantially less than the field of view which the user can see by moving his eyes to one side or the other or up or down. Thus, the user may be able to observe signals which are not seen by the head camera. The head camera can be designed to have a wide field of view and may also require that the glasses worn by the users contain shades which prevent the user from observing areas which exceed the field of view of the head camera. The tablet mounted camera can be used to ascertain that the user is properly wearing his or her glasses so as to prevent momentary displacement of the glasses and head camera to allow for a temporary peripheral glance by the user.

As mentioned above, the glasses containing the head camera will also contain RF sensors 65 and microphones 64. In one embodiment, two RF sensors and two microphones will be used; however location of a source of sound or radiofrequency can be detected by adding a third microphone and a third RF sensor. This third microphone and RF sensor can be positioned on the glasses or other locations in the environment. By triangulation the source of either sound or radio frequency can be located. All of the devices that make up a headset can be multiplexed into a single USB cable which then can be plugged in to the tower as provided.

In FIG. 6E, there are glasses 130 worn by the user allowing the user only to see the remote session. These glasses are designed to fit over prescription glasses and can be part of the headset which contains the microphones, head camera and RF sensors. The use of display glasses such as Google glass is somewhat more difficult to hack and therefore more secure. The tablet camera, for example, can monitor the face of the user to determine that there are no hidden imagers watching the glasses display. There still remains the possibility of capturing information in the wires to the display but through placing a microprocessor within the display and feeding only encrypted display information through the wires the chance of this happening is minimized. The disadvantage of the display glasses rests in the fact that the user can still see potential information sources that would be unavailable to the goggles wearer.

In one embodiment, the tablet is only a display; the standalone monitoring system 20 includes a central processing unit that communicates with the glasses 130, the display, and the input devices 144, 140. The central processor will receive the remote session questions through the networked environment and display each question only on the user's glasses. The standalone monitoring system 20 will provide the user with a data entry screen for entering the answer to the remote session question with the input devices. The standalone monitoring system 20 will be totally sealed and will be tamper resistant, i.e., which cannot be opened without destroying the tower housing. Various methods of detecting housing breach using an intrusion detector can be implemented more easily with such a tower than with a laptop or tablet, which is designed to be serviced.

The embodiments of the computing device 104, the standalone monitoring system 20 (with or without a separate computing device) provide control over ports through a secure operating system and prevent attachment of devices which could support the transfer of information out of the system to a consultant. If the device is the computing device 104, the control is through the operating system when the computer is operating in a secure mode which is different from the standard operating system. In addition, use of a spherical camera allows monitoring of the entire space surrounding the user to detect the presence of helpers or of changing text displayed on a wall or ceiling. The systems provide the ability to detect the existence of a consultant who would be out of the view of the typical camera which is present in a laptop or tablet by ultrasonic motion detectors or cameras. The use of strong encryption coupled with the protection of the private key which cannot be extracted from the computer.

The use of a chassis intrusion detection sensor renders the physical breach of the standalone monitoring system 20 or computing device 104 chassis virtually impossible without destroying the private key used for remote session decryption. Some intrusion detection sensors include a light sensing sensor which records an incident if the housing has been opened and light enters or a mechanical switch or other electrical connection that is disrupted upon opening of a housing. One intrusion defense is to replace the screws with fasteners which cannot be readily removed, such as screws that when screwed in and a threshold torque is obtained than the screw breaks off of the driving shaft. Alternatively, a tape can be securely attached to the joint of the housing with an adhesive such that the tape must be broken in order to remove the cover. If the tape is encoded with a complicated code which can be read by the tablet and if this code cannot be read or otherwise hacked and is destroyed during the removal of the tape then intrusion by cover removal can be detected and thus prevented. As an extreme measure, an entire back of the computing device 104 can be covered with a film which contains a distributed code in such a way that the breach of any portion of the film alters the code can be detected by the tablet.

The detection of sound adjacent the ears of the user such that anything that can be detected by the user's hearing can also be detected by the microphones prevent cheating. The placement of RF sensors adjacent the user's ears such that any RF communication to the user and in particular to an earpiece which the user may be wearing can be detected. Visual cues from a consultant which may be displayed out of the view of a standard tablet or laptop camera are detectable by the camera system and by the head camera. In particular, the existence of notes, a hidden tablet, or smartphone which the user can view will also be detected by the systems of this disclosure. The location of audio and RF signal sources can be determined to indicate whether those locations are within the room occupied by the user. The detection, for example, of a smart watch or other similar apparatus which can be hidden from view of a tablet or even the spherical camera but can be detected by the head camera. The use of neural network based pattern recognition algorithms allow for continuous improvement of this system. The use of a scrambled display and light valve glasses to permit the contents of the display to be only observed by the user and not capable of being captured in a meaningful way by a camera having a view of the display.

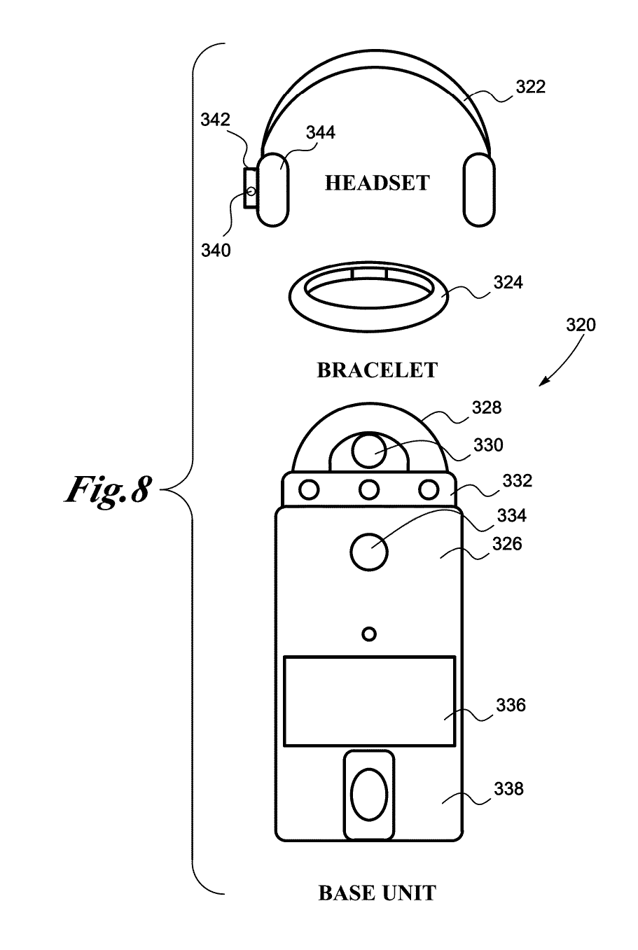

FIG. 8 is an alternative embodiment of a standalone monitoring system 320 that includes a tower 326, a headset 322, and a bracelet 324. The tower 326 may communicate with the headset and the bracelet wirelessly or through an electrical connection. In this embodiment, the tower 326 has a rectangular cross-section and houses a motherboard, not shown. On top of the tower is a tamper detection enabled cover 328 that houses at least one imaging device 330. The imaging device 330 may be configured to rotate around its place of attachment to view the entire remote session environment or may include a plurality of imaging devices to capture images or video of the remote session environment. Ultrasonic or other motion sensors 332 may be positioned between the cover 328 and the tower 326 or may be included within the cover 328. Other components, like a microphone/speaker 334, a input/output display panel 336, and a coupling interface 338 may be included.

The imaging devices 330 may be capable of biometric sensing for identification purposes, such as scanning a fingerprint, an iris, a face, a hand, or for detecting redness coloration patterns. For example, for a finger print scan, the user swipes his finger in front of the imaging device and the number and spacing of the ridges in the scanned area are recorded and processed, typically by counting the ridges.

The headset 322 may include a microphone 342 and an imaging device 340. The imaging device captures still and moving images of the environment around the user. The microphone 342 may detect the user talking to themselves. To combat this, during the initialization phase, the system may request a voice sample to compare and remove the user's normal voice during the remote session to avoid noting an inaccurate anomaly. Detection of a voice other than that of the online or other remote session-taker would be a good indication of the online or other remote session-taker cheating by receiving assistance from someone else. The headset 322 may also include speakers 344, one or more radio frequency communication-detecting sensors included within the headset.

Another way for the online or other remote session-taker to violate the rules of the remote session while wearing the frame would be for the user to type questions onto a smartphone or a second tablet or other type of computer, or to provide this smartphone or computer with voice-recognition that converts the online or other remote session-taker's speech into a communication. To prevent this type of rule violation, the system 20 or tablet computer being used for online or other remote session-taking should be configured to detect such communications.

In one embodiment, the standalone monitoring system 320 is configured to operate in conjunction with dual-mode tablet computer. The dual modes being normal operation and test taking operation. During test taking, the standalone monitoring system 320 will control the tablet computer and prevent internet access or other types of communications to or from the computer. During test taking a limited operating system will be enabled. This dual mode can be accomplished with a physical switch or, more likely, through software where the online or other remote session-taker is asked to choose which operation system he desires when booting up the tablet or controlled by the standalone monitoring system 320. The test is can be configured so that it will only operate when the restricted operating system is operating.

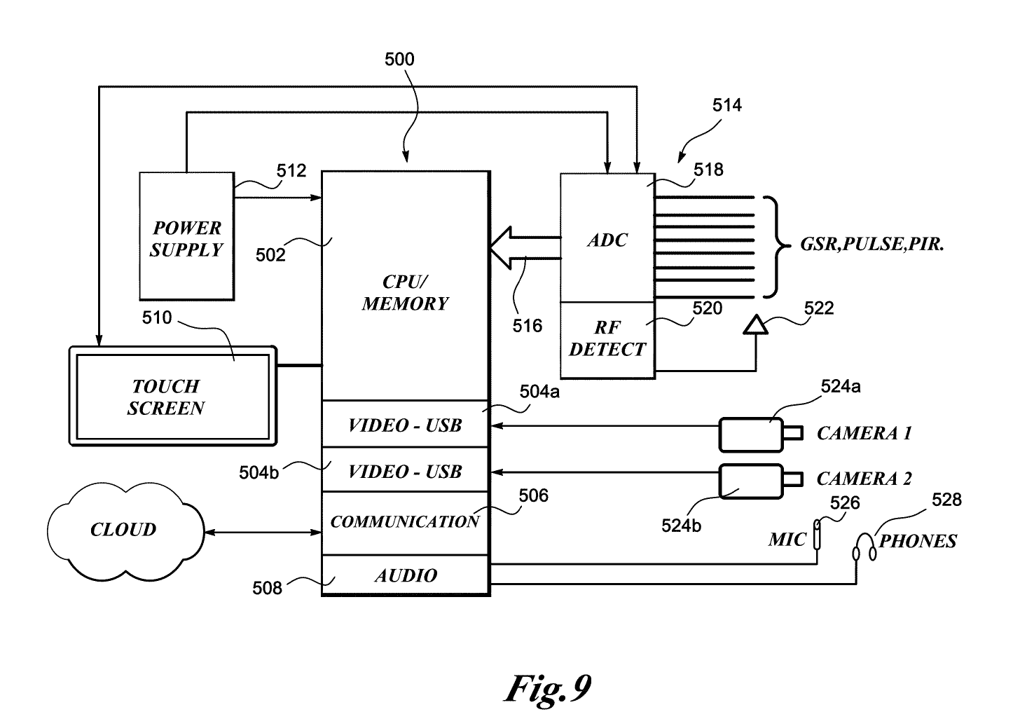

FIG. 9 is a block diagram of components internal to and external to a standalone monitoring system or a computing device according to embodiments of the present disclosure. A system hub 500 includes a central processing unit 502 that includes memory, video or graphics processing units 504a, 504b, an external communication unit 506, and an audio processing unit 508. These units may be distinct or combined units. A touch screen display 510 couples to the system hub 500 and is controlled by the system hub 500. A power supply 512 couples to the hub 550. A sensor system 514 couples to the hub and is configured to transmit sensor data 516 to the central processing unit 502. The sensor system 514 includes an analog to digital converter 518 that convert signals from a variety of sensors from analog to digital signals. The variety of sensors may include a galvanic skin response sensor, a pulse sensor, or a passive infrared sensor. An RF detection sensor 520 may also be part of the sensor system. The RF detection system may include an antenna 522. A plurality of cameras 524a, 524b couples to the graphics processing units. A microphone 526 and speakers 528 couple to the audio processing unit.

The sensor system 514 may be fully contained within the system hub or may be partially integrated. The sensor system may also detect using the touch screen 510. Data collected and processed by the hub can be transmitted to an external database through the communication unit 506, which could include Ethernet and other communication protocols.

The central processing unit 502 may include sensor algorithms that evaluate the data from the sensors for anomalous behavior. The memory will store date and time information about the remote session and time stamps associated with any anomalies. The hub is used as part of a proctoring device containing the plurality of sensors and electronic components that run both an internal operating system and software to interpret data from the sensors. If an anomaly is detected, the hub may provide immediate live feedback to the user based on the sensed conditions. The hub may send remote session data to a cloud-based computing infrastructure that connects and acts as the central repository for all exam session archive data. This cloud based computing infrastructure can be the verification and analytical engine used for both processing of live exam session data and for the aggregate analysis of archived exam session data.

A first step in an exam taking process is verifying identity. In one embodiment, there is a two-step process to unlock the device and connect to the test server. If the user is a returning user, biometric sensing can unlock the standalone monitoring system 20 or the computing device 104. For example, using facial recognition, voice recognition, and thumbprint verification the device can be unlocked. This information is “hard coded” into the device at the time the user is registered for the event/course. In this embodiment, the user never uploads any biometric info to an upstream server. This eliminates the concern of having permanent and unique personal data compromised by a security breach. The user physically retains the device and it is encrypted and stored on the device without the need to be connected to any external data subsystem.

Once unlocked using the biometrics, the user can then connect to the external server by way of an encrypted, secure login with user selected password and an institutional supplied ID (i.e. user ID). Once a secure path is established, the system is ready to begin a session.

As mentioned before, computing device 104 and the standalone monitoring system 20 and any peripheral components have the ability to detect if covers have been removed, opened or modified. If the sensing detection circuit is activated by mechanical tampering the Non Volatile memory can be “wiped” and all settings returned to a default value upon power up. The device will provide tamper detect regardless of power conditions.

A second step in the exam process is continuing to detect presence of the user to confirm that the remote session is completed without introducing a surrogate or leaving the user environment. In addition, any event or anomaly can be captured and time stamped into an event log. For example, a hard wired pulse detector can record the pulse of the user for the entire remote session, the cameras can video the user continuously, random requests to reenter biometric identification information, gaze tracking by analyzing the images from cameras, random prompts to respond into the microphone (potentially voice recognition), random prompt for gesture recognition by the audio system or visually on the display, such as “Raise left hand”/“Hold up two fingers.” Any anomalies are time stamped so they can be reviewed against the continuous video. Real time feedback can be provided to the users so corrective action can be taken by the user during the session.

A third step is behavioral analysis by capturing and recognizing behavioral events/anomalies, such as continuously monitoring by video, pulse detection, and microphone for example. Also, detecting for the presence of cell phone communications in the environment or facial/gesture recognition technology can discriminate events/anomalies. Repetitive movements that would indicate deceptive behaviors including looking into the users lap, reaching into pockets, manipulating a mobile device, etc. are looked for. Also, anomalies may be detected by monitoring for changes in amplitude and/or frequency as to detect anxiety and therefore trigger an even/anomaly. Identification of combinatorial event triggering, such as elevated pulse and strange movements that can be detected by video can trigger an event or anomaly.

A fourth step is monitoring the test environment by capturing and recognizing environmental events/anomalies, such as changes in ambient light levels. The ambient light levels may be monitored by the video system to ensure image capture system is operable. Also, RF detection is employed to ensure mobile devices are not operated within the user environment. Continuous and still images captured of the environment can be compared with a base line image for anomalies. Motion detection will ensure the user environment is not changing and that any disruption of the environment is recognized by the system. The system can detect and report on the presence of an active cellular device in the environment. Real time feedback is provided to the user of environmental anomalies and events so corrective action can be taken by the user during the session. Also, detection of an “in-ear” audio device being employed by the user during a session can assist in monitoring anomalies in the environment.

Another embodiment of the present disclosure is directed to a system that includes a standalone electronic device that includes embedded software that connects in real-time to a cloud-hosted service platform. This provides automated, remote secure proctoring for users enrolled in online courses and validates user identity and rates behavioral compliance throughout the remote session. This system can authenticate the presence of the user throughout the session and validate conformity to test taking rules.

The system constantly monitors the user during the remote session and provides real-time feedback to the user about whether they are conforming to the behavior requirements of the system. In particular, this system is configured monitor the user and create an remote session history that can be reviewed at a later date to eliminate an on-site or remote proctor. The remote session history reflects the remote session as recorded using a variety of sensors. For example, one of the sensors may be a video camera. The remote session history will include indicators of when the user's behavior fell outside of the behavior requirements. As noted, the user, during the remote session will be notified if their behavior is outside of the behavior requirements. This gives the user an opportunity to correct their behavior. For example, if the user rotates their chair and leans back as they are thinking through a problem, the sensors will register that the user is no longer facing a computer running the remote session. The system may notify the user with a small noise or a flashing light. The system may include a timer that will only notify the user if they exceed a preselected amount of time in the non-standard position. That way, minor movements will not be stored as a violation of the behavior requirements.

The electronic device may include Hall Effect sensors to detect mechanical tampering. The may be running at all times using an internal rechargeable battery. The electronic device may also include a scrolling LCD display on the tower to indicate and help the user correct issues. The speaker may also provide an audible tone to remote session-taker to indicate non-compliance or other risk. The system may include voice recognition software to determine identity. The system may be configured to acquire a pre-test set of biometrics to get baseline of the user's vital signs for comparison during the test or for later remote sessions. The system includes an algorithm the processes all of the data taken in by the tower and provides the remote session history to the school for storage and later analysis if needed.

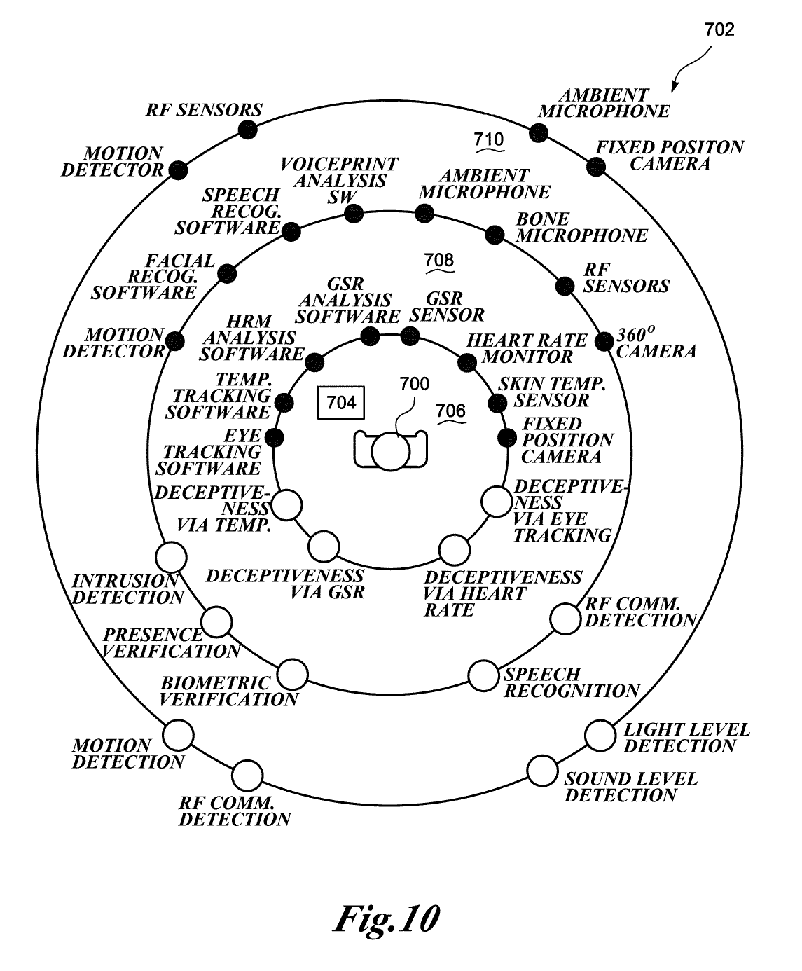

FIG. 10 is a representation of areas around a user 700 and types of sensing or monitoring in these areas according to the present disclosure. The user 700 is a center of a sensing and monitoring area 702. A computing device or a standalone monitoring system 704 are positioned in front of the user 700. The system or device 704 sense a variety of behavioral and presence factors within a first area 706. For example, within the first area the system or device 704 detects abnormal eye movement, changes in temperature of the first area 706 or of the user, heart rate changes, and galvanic skin response changes. The abnormal eye movement can be tracked by the fixed position camera. The temperature can be detected by a sensor affixed to the user, such as the bracelet or headset described herein. A heart rate monitor in the bracelet, the headset or in a chest strap can monitor the heart rate changes. A galvanic skin response sensor can detect the galvanic changes. Also within the first area, biometric processing can occur using deceptiveness detection via temperature, galvanic skin response, heart rate, and eye tracking, alone or separately.

In a second area 708 around the user 700, the system or device 704 includes a motion detector or facial recognition, which can be performed by a wide angle or 360 degree style camera. Also, a bone microphone or other microphone can be used for speech recognition or voiceprint analysis. Also an ambient microphone can detect abnormal sounds in the area. The second area 708 includes the first area. The second area also provides a range of space around the user 700 for behavioral proctoring, which can include intrusion detection, presence verification, biometric verification, speech recognition, and RF communication detection.

A third area 710 includes both the second area 708 and the first area 706. In this area, motion detectors, RF sensors, ambient microphones, and fixed and wide angle cameras detect anomalies in the environment for environmental proctoring.

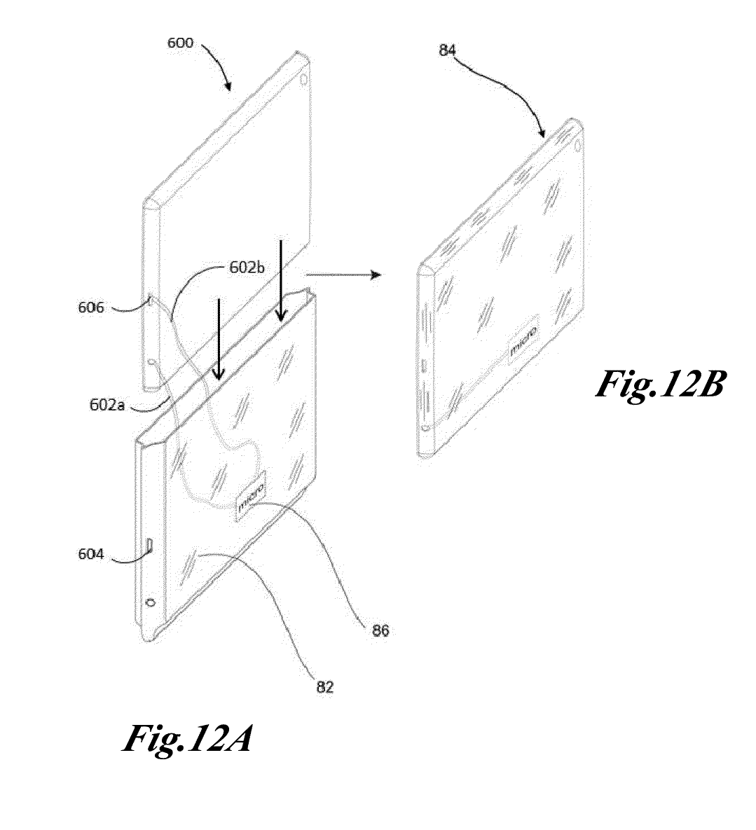

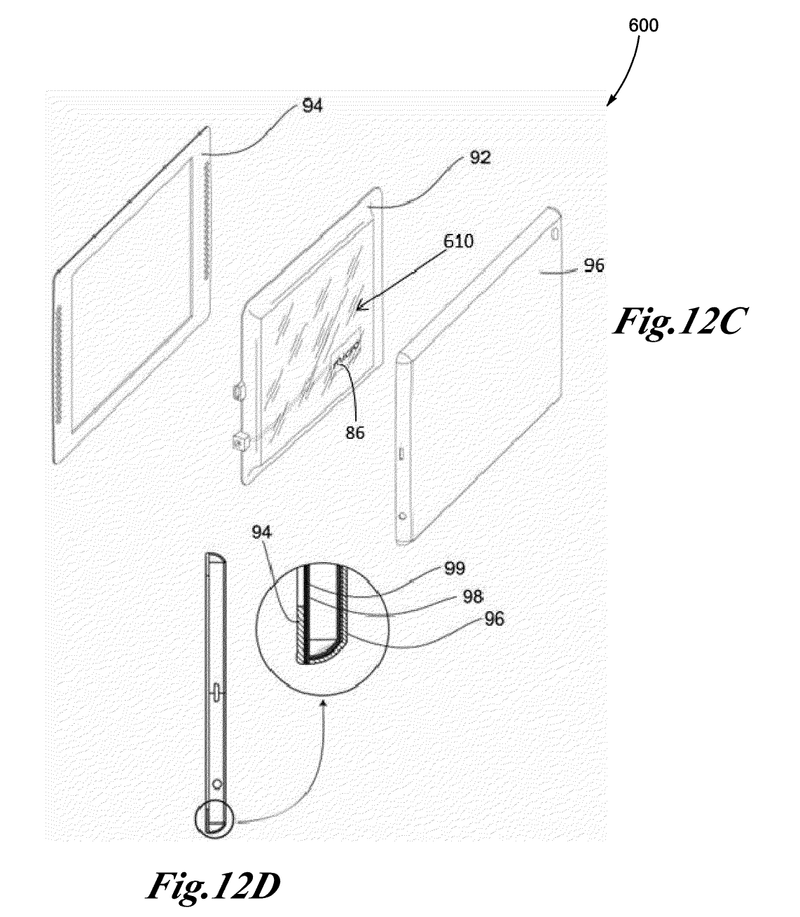

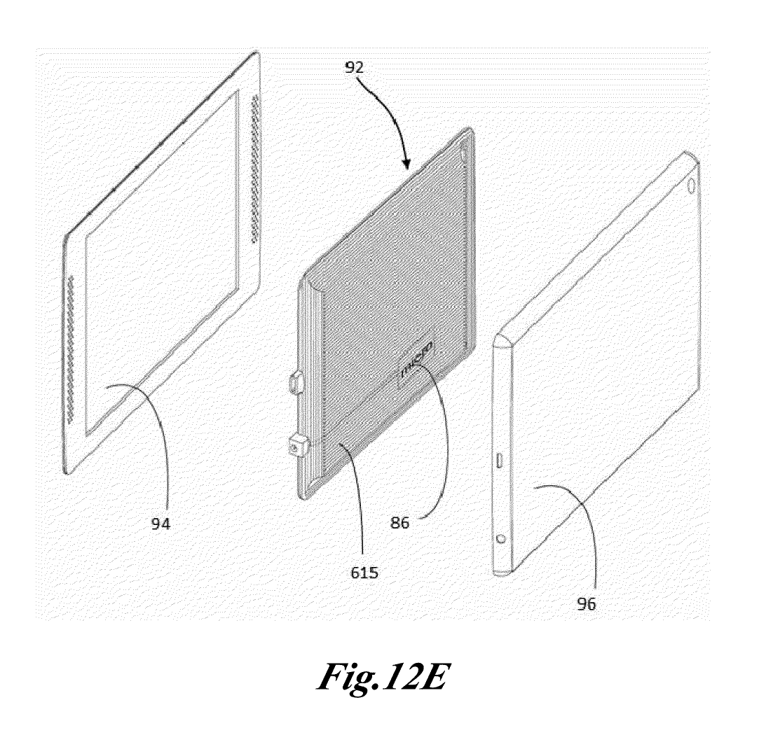

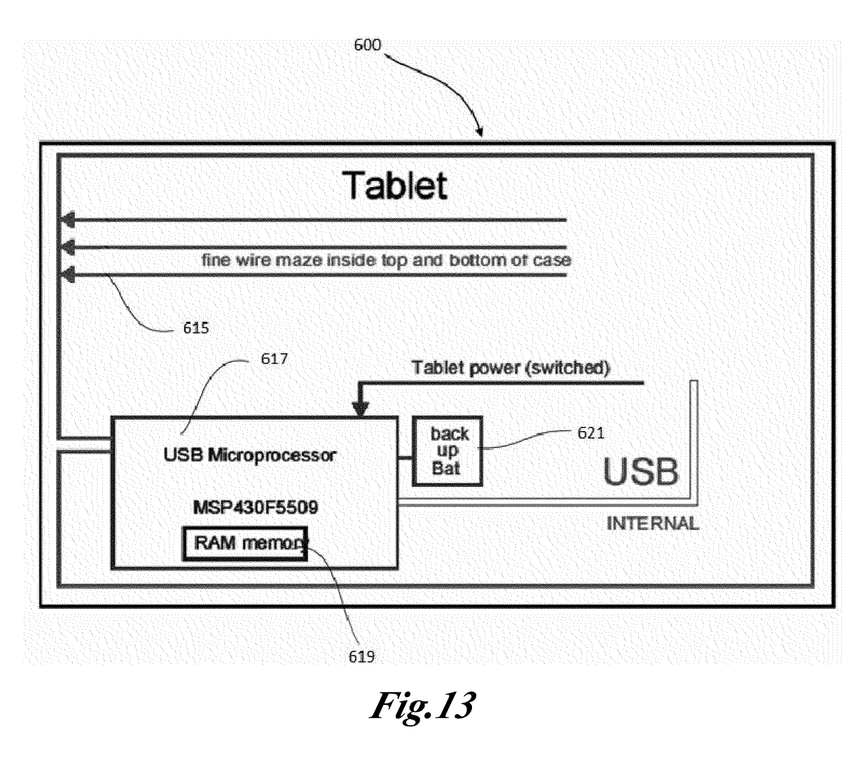

FIGS. 12A-12D are embodiments of computing devices that include a chassis Intrusion detector systems. FIG. 16A is a tablet computer 600 that is placed in a conductive plastic envelope 82. A security monitoring device 86 is within the envelope 82 and electrically coupled to the table computer 600 with wires 602a, 602b, such as through existing ports. Openings 604 are included to provide access to ports 606 on the tablet. FIG. 12B is the assembly of the tablet 600 in the envelope 846 and forms a sealed chassis intrusion defense system 84. The envelope 82 may be folded over to seal the tablet computer 600. The envelope can be heat treated to shrink the envelope around the tablet computer to make the chassis intrusion detection system.

The envelope may be a conductive mesh that transparent so that it does not interfere with viewing the screen of the tablet computer. This can be eventually using graphene or indium tin oxide.

FIGS. 12C and 12D are disassembled and assembled parts of the tablet computer 600, including a front cover 94, a back cover 96, and display assembly components 92. The security monitoring device 86 is included with display assembly components, such as a chassis intrusion detection film 610, so that the security monitoring device 86 is within the tablet computer. The film 610 is glued 99 to the assembly components or to the back cover 96. In one embodiment, the film extends slightly outside of the area of the cover, see FIG. 12D. The security monitoring device 86 can be attached to the film and plug into the motherboard; this can be through an existing port in the tablet computer. When the cover is attached to the remainder of the tablet computer it is firmly glued or heat sealed in place so that once attached the cover cannot be removed from the remainder of the tablet without destroying the cover. The film is arranged so that it is also glued to the interface and partially to the area above the interface. Thus any attempt to breach the tablet will damage the film.

In FIGS. 12C-12D, the film contains two layers of conductive film arranged in close proximity to each other with approximately a spacing of 0.001 inches and covered by a thicker plastic film of approximately 0.02 inches on each side resulting in a total thickness of approximately 0.043 inches. An alternate construction is to use a pattern of small conductive wires 615 which can, for example, be 0.005 inches wide with a similar spacing between the wires as shown in FIG. 12E. Typically these wires will appear in pairs and will meander throughout the film. The security monitoring device 86 will be connected to the ends of these wires and continuously monitor their resistance and mutual inductance. If there is any change in the geometry of these wires in the mesh after assembly of the cover to the tablet then this will be sensed by the security monitoring device 86 and the memory will be erased thereby destroying the private key.

The mesh of wires 615 can be economically produced by xerographic techniques resulting in a very low cost chassis intrusion detector system. Any disruption of the mash or conductive film in either of the above described examples will destroy the private key making it impossible to decode the test questions or will deactivate the standalone monitoring system 20 or the computing device 104. After the assembly is completed, the computer can be powered on and the first step would be to measure the inductance, resistance, and capacitance of the mesh. Thereafter if any of these measurements significantly change then the circuit in the security monitoring device 86 would remove power from the memory thereby destroying the private key.

FIG. 13 is a schematic of the operation of the chassis intrusion detector system of FIGS. 12A-12E. An embedded microprocessor 617 is powered by a long term battery 621 and contains a RAM memory 619. The RAM memory contains the private key encryption code to decrypt the remote session data. The microprocessor continuously monitors the wires 615 and if there is any change in the resistance, mutual inductance or capacitance in the circuit, the microprocessor disconnects power from the RAM and the private key is erased.

Modern displays refresh the screen 50 at 240 Hz. Since the text on a test changes very slowly only a small portion of this information need be seen by the user. For example, if the screen displays constantly changing images which are very similar to the text on the test wherein only 5%, for example, of the images represent the actual test, then anyone observing the screen through one of the aforementioned cameras would see a blur of constantly changing text. If the user wears a set of glasses where the lenses are made opaque through liquid crystal technology such as is practiced then the lenses can be made transparent only during the 5% of the time that the display presents the remote session. The particular frames that contain the actual test questions can be randomized and the random code indicating which frames are to be seen it can be sent to the glasses control module in an encrypted form also protected with a chassis intrusion detection device such that only the glasses worn by the user know which frames to view.

The capacitance between these films is measured and monitored by the tablet. If any attempt is made to reach this film it is likely that one of the conductive layers will be shorted to the other which even if it happens momentarily can be detected. If one of the films is carefully removed, which would be extremely difficult, and then again the capacitance between the two films would be detectably altered. The two films can reside within a picture plastic assembly such that damage to the films through normal handling of the laptop would not likely to occur.

A key complement of the chassis intrusion detection systems described is the use of a small microprocessor and RAM assembly along with a small battery. The battery is connected to the microprocessor through small diameter wires. This assembly is potted such that any attempt to disassemble the assembly will break one or more of the wires connecting the battery to the microprocessor. The microprocessor interrogates the capacitance of the intrusion protection film such as once per second. The battery has sufficient stored energy to power the microprocessor for a long period such as 10 years. The assembly can also be connected to the laptop battery which would then maintain the 10 year battery fully charged. If the RAM loses power which can happen either through a command from the microprocessor if the capacitance of the film has changed or if the ten-year battery has been disconnected, the contents of the RAM memory will be erased. This RAM memory upon structure and of the laptop for test taking purposes would contain the private key associated with that laptop.

As generally used herein, a “tablet computer” is a portable computing device that includes hardware and software for conventional functionality for outputting questions (visually and/or audibly) and receiving via one or more user interfaces, responses to the questions.

The present disclosure is configured to provide secure remote session to an individual user with a secure monitoring system. The system is a standalone system that can be moved to any location where the user wants to take a test. The system can be programmed upon purchase or at a later time with biometric and other identifying information to recognize and verify a particular user is the actual user registered for the test and authorized to use the system. The biometric and other identifying information can be stored in the specific system, where access to the device is limited to authorized users that match the stored biometric and other identifying information. Alternatively, the system can be connected to a database that houses all of the biometric and other identifying information for users authorized or registered to take the remote session, where an access code may be shared with the user via email that activates and allows the system to access the biometric and other information in the database. This system may operate in an online mode or in an offline mode.

This system provides automated monitoring, where no other person is utilized to monitor the user. The system verifies the user's identity, such as with a facial scan plus a password and a unique ID number (user ID). This information may be gathered by a camera or input on touchscreen associated with the system. The entered information is compared with previously submitted information to verity identity.

The system may have a two or multiple step unlocking process. For example, biometric deification to access the software in the system, then specific course information to access the exam information and remote session parameters. The individual biometric information and other information may be stored by a portion of the system that is isolated for the other parts of the system. This can prevent the unwanted transmission of this personal information.

The system also monitors the presence of the user through the exam session. In particular, to ensure no unauthorized parties enter the remote session area. If some other person is detected, such as with heat detection or video analysis, the system may pause the exam, store time information about the detected situation, and notify the user to correct the situation. This provides real time feedback to the user of presence anomalies and events so corrective action can be taken by the user during the session.

The system also monitors the user for behavioral integrity. For each abnormal event detected, there is a running log capturing events and time stamping each to correlate to video and still images as evidence of behavior, environment, presence or identity of the user. Logged or stamped events can be compared and analyzed at a later time with the full video captured of the exam session. The system also monitors for transmissions through the cell phone spectrum.

The system monitors stress and deceptiveness. All events and anomalies can be viewable by the user as a flag, warning, or visual alarm during the remote session or as a summary at the end. This may be displayed on the display screen, such as 12 anomalies captured. Proctoring parameters may be provided by the test provider or default settings may be used. The anomaly information can be stored and saved in the cloud for post processing and analysis.

The system also monitors the security of the test environment and creates a remote proctoring environment that avoids a physical proctor monitoring the remote session. The display on the system may be a touch screen or LCD module with touch capabilities, including tactile feedback and the ability to be illuminated. The display may be a removable component.

The system may perform facial recognition periodically through the remote session with or without prompting the user. It is possible to perform a facial scan while the user is working on the test questions, such as with one of the cameras. The system also discriminates events/anomalies, such as repetitive movements that would indicate deceptive behaviors including looking into the users lap, reaching into pockets, manipulating a mobile device, etc.

The system includes motion detectors, such as infrared sensors that may operate within a 15 foot range of the system. Other sensors include passive infrared sensors with trigger rate, such as 2× per second or passive infrared ambient light sensors to identify low light conditions. Other sensors can detect cell phone signals, such as the presence of unauthorized Wi-Fi signals, cellular network signals, Bluetooth signals, such as between 824 and 894 MHz. If any unauthorized signals are detected, the system will store and log anomaly information.

Moreover, aspects of the various embodiments described above can be combined to provide further embodiments. U.S. Provisional Application Ser. Nos. 61/861,532, 61/925,035, 61/970,303, are incorporated herein by reference in their entirety. Aspects of the embodiments can be modified if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A system, comprising:
a support structure that includes:
a base;
memory;
a display and user interface;
a plurality of sensors, including:
a first camera;
a second camera, the first camera being positioned between the second camera and the base;
audio sensors;
a plurality of biometric sensors;
a transceiver; and
processing circuitry coupled to the plurality of sensors and to the transceiver, the processing circuitry configured to analyze signals from the plurality of sensors and to output anomaly data to the display and user interface and to store the anomaly data in the memory.

2. The system of claim 1 wherein the audio sensor outputs an audio signal and receives an return audio signal, the processing circuitry compares the audio signal with the return audio signal to detect audio anomalies.

3. The system of claim 1 wherein the plurality of biometric sensors include a fingerprint scanner and a pulse detector.

4. The system of claim 3 wherein the processing circuitry performs identification verification with the fingerprint scanner and performs a facial recognition scan with images from the first camera, the processing circuitry compares images from the first by comparison of biometric sensor data in the memory.

5. The system of claim 1 wherein the processing circuitry controls the transceiver and transmits anomaly data and remote transaction session data to a remote server.

6. A system, comprising:
a standalone monitoring device including:
a display and user interface that provides information to a user and receives inputs from the user;
a microphone;
a fixed camera that faces a user;
an adjustable camera that scans a remote session environment where the user is positioned;
processing circuitry that receives and analyzes signals from the display, the microphone, the fixed camera, and the adjustable camera; and
a first wearable electronic biometric sensing device that collects data from the user and transmits data to the processing circuitry.

7. The system of claim 6, further comprising a second wearable electronic biometric sensing device that collects data from the user and transmits data to the processing circuitry.

8. The system of claim 7 wherein the first wearable biometric sensing device is a bracelet and the second wearable biometric sensing device is a headset.

9. The system of claim 8 wherein the bracelet includes a pulse monitor, a galvanic skin response sensor, a GPS module, an RFID or NFC chip, and a skin temperature sensor.

10. The system of claim 8 wherein the headset includes speakers, microphone and a head-mounted camera.

11. A device to monitor a user, comprising:
a support structure;
at least one audio sensor configured to detect sound and arranged on said support structure;
at least one radio frequency communication detecting sensor arranged on said support structure;
at least one optical imaging device configured to obtain images of an area including a computer of the user and arranged on said support structure;
at least one biometric sensor configured to receive data from the user;
at least one motion sensor system configured to detect motion in an area around the user; and
a processing unit coupled to said at least one sound sensor, said at least one radio frequency communication detecting sensor, said at least one optical imaging device, said at least one biometric sensor and said at least one motion sensor and that receives and analyzes data to determine whether the user interacts with another person during an remote session.

12. The device of claim 11 wherein said at least one optical imaging device is a 360° field of view camera assembly.

13. The device of claim 11 wherein said at least one optical imaging device comprises a fisheye lens.

14. The device of claim 11 wherein said support structure is wearable and includes a housing and a strap for attaching said housing to the user.

15. The device of claim 14 wherein said at least one optical imaging device is arranged on said housing.

16. The device of claim 11 wherein said at least one motion sensor comprises an ultrasonic sensor system.
